(19) United States
(12) Patent Application Publication
(10) Pub. No.: US 2026/0143556 A1
(43) Pub. Date: May 21, 2026

(54) WIRELESS NETWORK ENERGY SAVINGS SYSTEMS VIA DISCONTINUOUS COMMUNICATION

(71) Applicant: Samsung Electronics Co., Ltd., Suwon-si (KR)

(72) Inventors: Ebrahim MolavianJazi, San Jose, CA (US); Aristides Papasakellariou, Houston, TX (US); Hongbo Si, Allen, TX (US)

(21) Appl. No.: 19/379,526

(22) Filed: Nov. 4, 2025

Related U.S. Application Data
(60) Provisional application No. 63/723,067, filed on Nov. 20, 2024.

(51) Int. Cl. H04W 76/27

(52) U.S. Cl. CPC H04W 76/27

(57) ABSTRACT

Apparatuses and methods for energy savings in wireless systems via discontinuous communication. A method for a user equipment (UE) includes receiving first information for time resources of candidates for a sequence-based downlink wake-up signal (DL WUS), receiving second information for parameters of a cell discontinuous transmission or discontinuous reception (DTX/DRX) operation, and determining, based on the second information, a non-active period of the cell DTX/DRX operation. The method further includes determining, during the non-active period of the cell DTX/DTX operation, to skip receptions of first synchronization signals and receive, based on the first information, the candidates for the DL WUS within the time resources, receiving, during the non-active period of the cell DTX/DRX operation, a first candidate from the candidates that provides a first DL WUS, determining, based on the first DL WUS, to receive a number of second synchronization signals, and receiving the number of second synchronization signals.

### CROSS-REFERENCE TO RELATED AND CLAIM OF PRIORITY

The present application claims priority under 35 U.S.C. § 119(e) to U.S. Provisional Patent Application No. 63/723,067 filed on Nov. 20, 2024, which is hereby incorporated by reference in its entirety.

### TECHNICAL FIELD

The present disclosure relates generally to wireless communication systems and, more specifically, the present disclosure is related to apparatuses and methods for energy savings in wireless systems via discontinuous communication.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to energy savings in wireless systems via discontinuous communication.

In one embodiment, method for a user equipment (UE) is provided. The method includes receiving first information for time resources of candidates for a sequence-based downlink wake-up signal (DL WUS), receiving second information for parameters of a cell discontinuous transmission or discontinuous reception (DTX/DRX) operation, and determining, based on the second information, a non-active period of the cell DTX/DRX operation. The method further includes determining, during the non-active period of the cell DTX/DTX operation, to skip receptions of first synchronization signals and receive, based on the first information, the candidates for the DL WUS within the time resources, receiving, during the non-active period of the cell DTX/DRX operation, a first candidate from the candidates that provides a first DL WUS, determining, based on the first DL WUS, to receive a number of second synchronization signals, and receiving the number of second synchronization signals.

In another embodiment, a UE is provided. The UE includes a transceiver configured to receive first information for time resources of candidates for a sequence-based DL WUS and receive second information for parameters of a cell DTX/DRX operation. The UE further includes a processor operably coupled with the transceiver. The processor is configured to determine, based on the second information, a non-active period of the cell DTX/DRX operation and determine, during the non-active period of the cell DTX/DTX operation, to skip receptions of first synchronization signals and receive, based on the first information, the candidates for the DL WUS within the time resources. The transceiver is further configured to receive, during the non-active period of the cell DTX/DRX operation, a first candidate from the candidates that provides a first DL WUS. The processor is further configured to determine, based on the first DL WUS, to receive a number of second synchronization signals. The transceiver is further configured to receive the number of second synchronization signals.

In yet another embodiment, a base station is provided. The base station includes a transceiver configured to transmit first information for time resources of candidates for a sequence-based DL WUS and transmit second information for parameters of a cell DTX/DRX operation. The base station further includes a processor operably coupled with the transceiver. The processor is configured to determine, based on the second information, a non-active period of the cell DTX/DRX operation and determine, during the non-active period of the cell DTX/DTX operation, to skip transmissions of first synchronization signals and transmit, based on the first information, the candidates for the DL WUS within the time resources. The transceiver is further configured to transmit, during the non-active period of the cell DTX/DRX operation, a first candidate from the candidates that provides a first DL WUS. The processor is further configured to determine, based on the first DL WUS, to transmit a number of second synchronization signals. The transceiver is further configured to transmit the number of second synchronization signals.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure using orthogonal frequency division multiplexing (OFDM) according to embodiments of the present disclosure;

FIG. 6 illustrates an example of a receiver structure using OFDM according to embodiments of the present disclosure;

FIG. 7 illustrates an example encoding structure for a downlink control information (DCI) format according to embodiments of the present disclosure;

FIG. 8 illustrates an example decoding structure for a downlink control information (DCI) format according to embodiments of the present disclosure; and

FIG. 9 illustrates a flowchart of an example method performed by a UE in a wireless communication system according to embodiments of the present disclosure.

### DETAILED DESCRIPTION

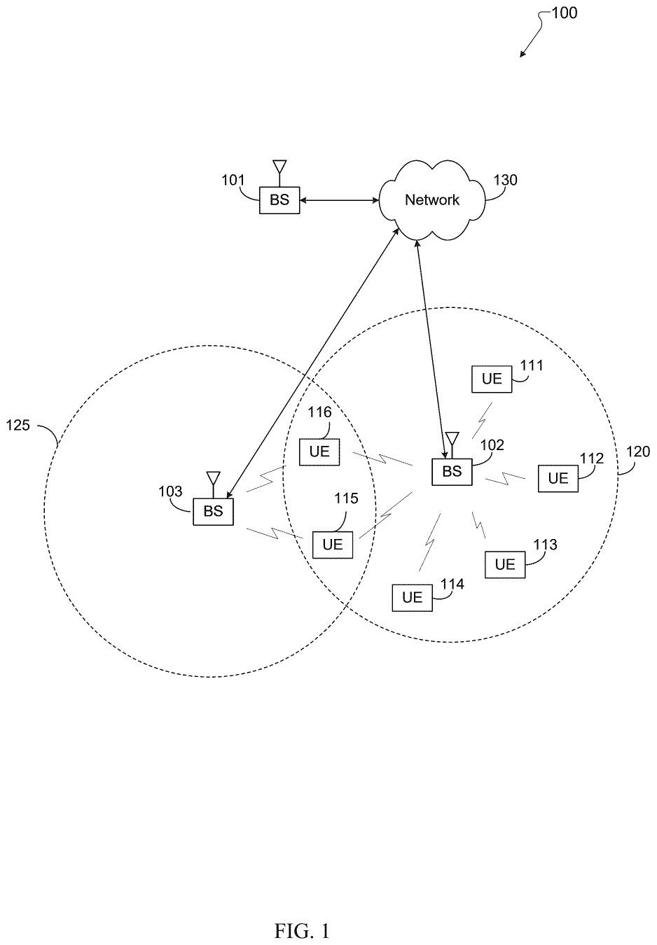

FIGS. 1-9, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1]3GPP TS 38.211 Rel-18 v18.4.0, “NR; Physical channels and modulation;” [REF 2]3GPP TS 38.212 Rel-18 v18.4.0, “NR; Multiplexing and channel coding;” [REF 3]3GPP TS 38.213 Rel-18 v18.4.0, “NR; Physical layer procedures for control;” [REF 4]3GPP TS 38.214 Rel-18 v18.4.0, “NR; Physical layer procedures for data;” [REF 5]3GPP TS 38.215 Rel-18 v18.4.0, “NR; Physical layer measurements;” [REF 6]3GPP TS 38.321 Rel-18 v18.3.0, “NR; Medium Access Control (MAC) protocol specification;” [REF 7]3GPP TS 38.331 Rel-18 v18.3.0, “NR; Radio Resource Control (RRC) protocol specification;” and [REF 8]3GPP TS 38.300 Rel-18 v18.3.0, “NR; NR and NG-RAN Overall Description; Stage 2.”

FIGS. 1-3 below describe various embodiments implemented in wireless communications systems and with the use of OFDM or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to utilize energy savings in wireless systems via discontinuous communication. In certain embodiments, one or more of the gNBs 101-103 include circuitry, programing, or a combination thereof to support energy savings in wireless systems via discontinuous communication.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

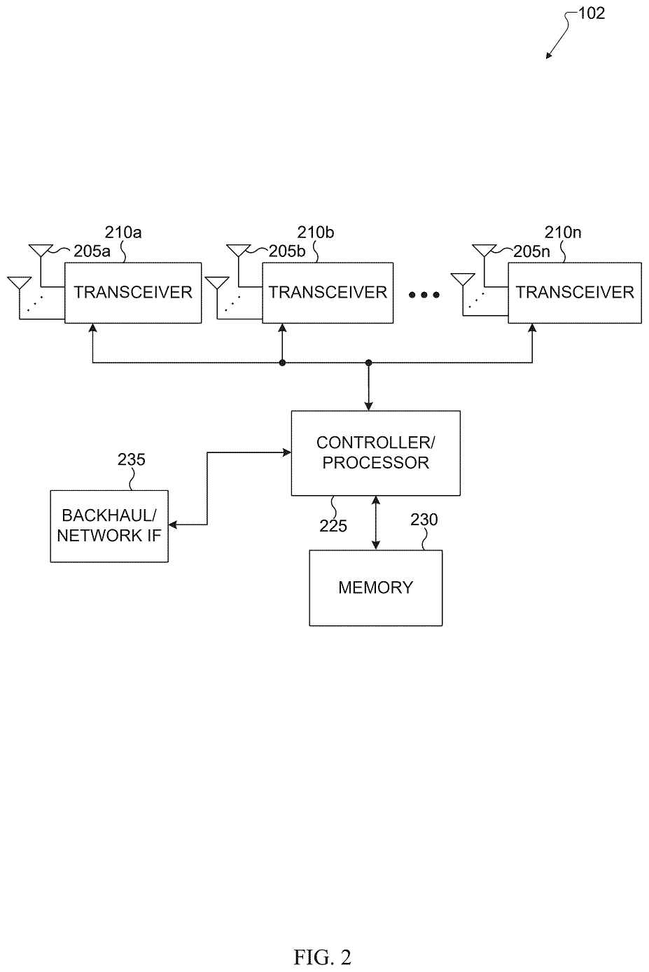

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as energy savings in wireless systems via discontinuous communication. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

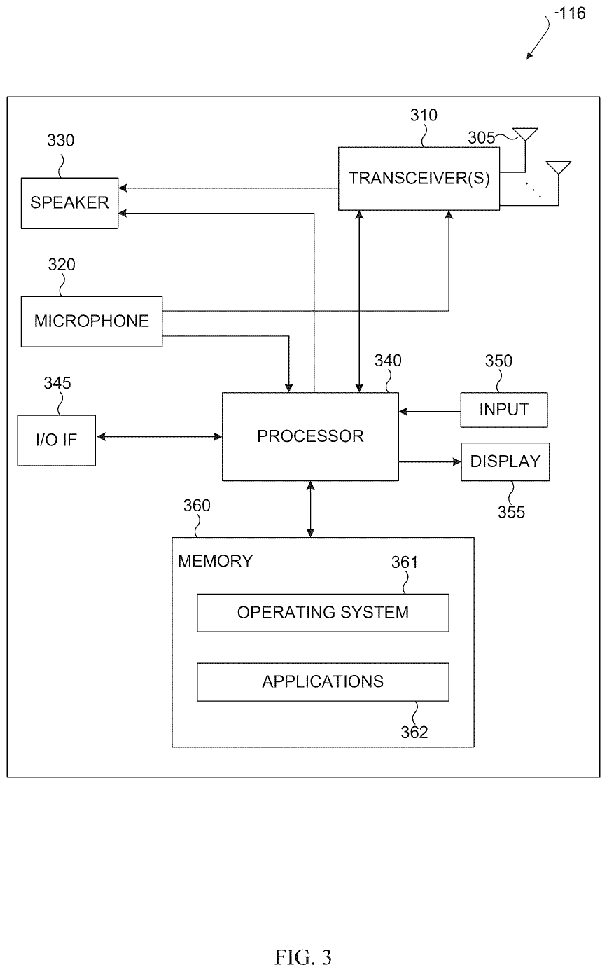

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support energy savings in wireless systems via discontinuous communication as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include volatile memory such as a random-access memory (RAM), and another part of the memory 360 could include non-volatile memory a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

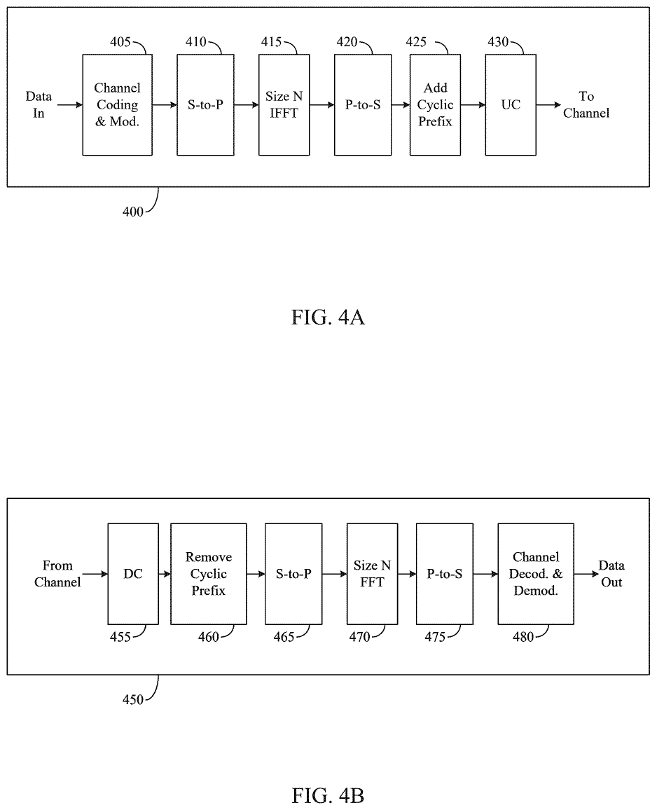

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for energy savings in wireless systems via discontinuous communication as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

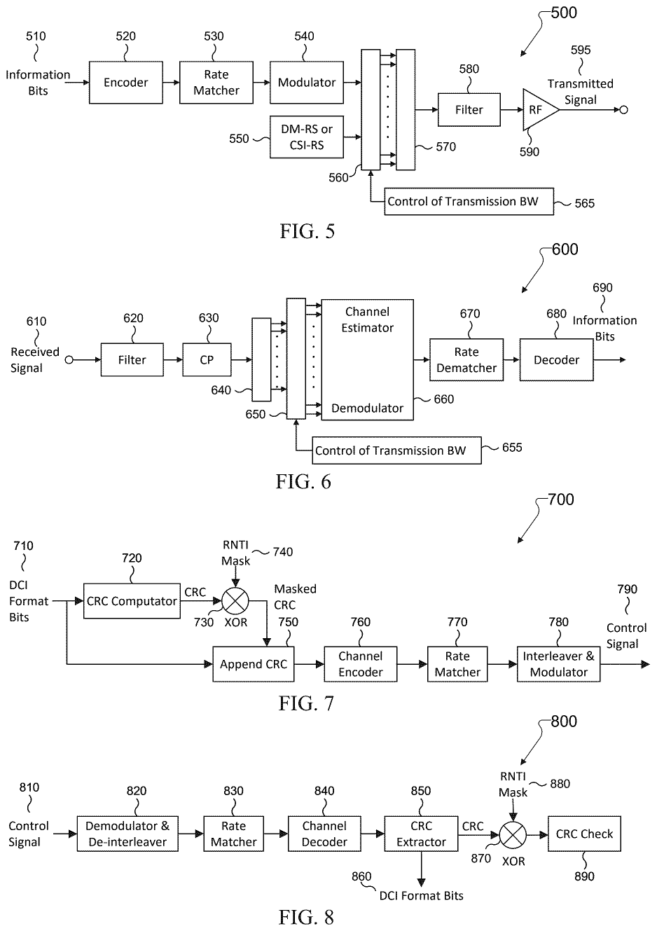

FIG. 5 illustrates an example of a transmitter structure 500 using OFDM according to embodiments of the present disclosure. For example, transmitter structure 500 using OFDM can be implemented in gNB 102 of FIG. 1. This example is for illustration only and other embodiments can be used without departing from the scope of the present disclosure.

Information bits, such as DCI bits or data bits 510, are encoded by encoder 520, rate matched to assigned time/frequency resources by rate matcher 530, and modulated by modulator 540. Subsequently, modulated encoded symbols and demodulation reference signal (DM-RS) or channel state information reference signal (CSI-RS) 550 are mapped to REs 560, an inverse fast Fourier transform (IFFT) is performed by filter 570. A BW selector unit 565, a filter 580, a radio frequency (RF) amplifier 590, and transmitted signal 595 are also included.

FIG. 6 illustrates an example of a receiver structure 600 using OFDM according to embodiments of the present disclosure. For example, receiver structure 600 using OFDM can be implemented by any of the UEs 111-116 of FIG. 1. This example is for illustration only and other embodiments can be used without departing from the scope of the present disclosure.

A received signal 610 is filtered by filter 620, a CP removal unit removes a CP 630, a filter 640 applies a fast Fourier transform (FFT), RE de-mapping unit 650 de-maps REs selected by BW selector unit 655, received symbols are demodulated by a channel estimator and a demodulator unit 660, a rate de-matcher 670 restores a rate matching, and a decoder 680 decodes the resulting bits to provide information bits 690.

With reference to FIG. 5, an example transmitter structure using OFDM according to this disclosure is shown.

With reference to FIG. 6, an example receiver structure using OFDM according to this disclosure is shown.

FIG. 7 illustrates an example encoding structure 700 for a downlink control information (DCI) format according to embodiments of the present disclosure. For example, encoding structure 700 can be implemented in gNB 102 of FIG. 1. This example is for illustration only and other embodiments can be used without departing from the scope of the present disclosure.

A gNB separately encodes and transmits each DCI format in a respective physical downlink control channel (PDCCH). When applicable, a radio network temporary identifier (RNTI) for a UE (e.g., the UE 116) that a DCI format is intended for masks a cyclic redundancy check (CRC) of the DCI format codeword in order to enable the UE to identify the DCI format. For example, the CRC can include 16 bits or 24 bits and the RNTI can include 16 bits or 24 bits. Otherwise, when a RNTI is not included in a DCI format, a DCI format type indicator field can be included in the DCI format.

The CRC of (non-coded) DCI format bits 710 is determined using a CRC computation unit 720, and the CRC is masked using an exclusive OR (XOR) operation unit 730 between CRC bits and RNTI bits 740. The XOR operation is defined as XOR(0,0)=0, XOR(0,1)=1, XOR(1,0)=1, XOR(1,1)=0. The masked CRC bits are appended to DCI format information bits using a CRC append unit 750. An encoder 760 performs channel coding, such as polar coding, followed by rate matching to allocated resources by rate matcher 770. Interleaving and modulation units 780 apply interleaving and modulation, such as QPSK, and the output control signal 790 is transmitted.

FIG. 8 illustrates an example decoding structure 800 for a DCI format according to embodiments of the present disclosure. For example, decoding structure 800 for a DCI format can be implemented by any of the UEs 111-116 of FIG. 1. This example is for illustration only and other embodiments can be used without departing from the scope of the present disclosure.

A received control signal 810 is demodulated and de-interleaved by a demodulator and a de-interleaver 820. A rate matching applied at a gNB transmitter is restored by rate matcher 830, and resulting bits are decoded by decoder 840. After decoding, a CRC extractor 850 extracts CRC bits and provides DCI format information bits 860. The DCI format information bits are de-masked 870 by an XOR operation with a RNTI 880 (when applicable) and a CRC check is performed by unit 890. When the CRC check succeeds (check-sum is zero), the DCI format information bits are regarded to be valid. When the CRC check does not succeed, the DCI format information bits are regarded to be invalid.

With reference to FIG. 7, an example encoding process for a DCI format according to this disclosure is shown.

With reference to FIG. 8, an example decoding process for a DCI format for use with a UE according to this disclosure is shown.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a time division duplexing (TDD) system, an SRS transmission can also provide a PMI for DL transmission. Additionally, in order to establish synchronization or an initial higher layer connection with a gNB, a UE can transmit a physical random-access channel (PRACH as shown in NR specifications).

In the following, unless otherwise noted, a parameter referenced in italics is provided by higher layers such as by RRC.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by MIB or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional secondary cell groups (SCGs) by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF3, TS 38.213].

The Synchronization Signal and PBCH block (SSB) includes primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with an remaining minimum system information (RMSI), the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network (e.g., the network 130) has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the gNB to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g., CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) includes a MIB and a number of SIBs, which are divided into Minimum SI and Other SI (OSI):
Minimum SI comprises basic information required for initial access and information for acquiring any other SI. Minimum SI includes:
   MIB contains cell barred status information and essential physical layer information of the cell required to receive further system information, e.g., CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e., upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC_INACTIVE state through Paging messages, and to notify UEs in RRC_IDLE, RRC_INACTIVE and RRC_CONNECTED state of system information change and ETWS/CMAS indications through Short Messages. Both Paging messages and Short Messages are addressed with paging RNTI (P-RNTI) on PDCCH, but while the former is sent on paging control channel (PCCH), the latter is sent over PDCCH directly (see clause 6.5 of TS 38.331).

The present disclosure recognizes that existing designs in 5G NR for Cell DTX/DRX supports disabling various signals and channels. However, Cell DTX does not disable certain essential reference signals or channels such as SSB or PDCCH monitoring according to Type-0/0A/1/1A/2/2A CSS sets, as well as CSI-RS reception, although CSI reporting is disabled for various cases. Similarly, Cell DRX does not disable certain transmission of SRS, and the UE may continue to transmit AP CSI on PUSCH, PUCCH for LRR. In addition, the interaction of LP-SS and LP-WUS with Cell DTX/DRX is not specified.

Cell DTX/DRX is based on parameters that are configured by higher layers, and parameters cannot be adapted to dynamic changes in the cell loading or traffic profile. In addition, unlike UE C-DRX, there is limited support for Cell group operation.

Once the gNB configured or indicates Cell DTX/DRX, there is limited support for the UE to wake-up the gNB, or to request to do so.

Accordingly, embodiments of the present disclosure recognize that there is a need for more flexible and adaptable Cell DTX/DRX procedure that support dynamic adaptation to cell loading and traffic profile, and varying levels of disabling the transmission or reception of signals and channels during Cell DTX/DRX. Embodiments of the present disclosure recognize that there is also a need to specify the UE procedures where essential signals or channels are disabled during Cell DTX/DRX, or energy-efficient methods that allow the UE to wake-up the gNB during Cell DTX/DRX.

The present disclosure provides methods and apparatuses to enable increased network power saving by adaptation and extension of Cell DTX/DRX procedures. Various methods or examples can also apply to other DRX/DTX operation, such as UE DRX procedure, or generally to any operation state for a UE/cell/carrier/TRP that results in enabling/disabling/adaptation of signals or channel in different time durations or in various time/frequency/spatial/power/code/sequence domains. Various methods or examples are described for “DTX/DRX” that can apply to either one or both (Cell/UE) DTX operation or (Cell/UE) DRX operation. Various methods or examples are described for only “DTX” or only “DRX”, while such methods or examples can apply to both (Cell/UE) DTX operation and (Cell/UE) DRX operation, or to any one or more operation states for a UE/cell/carrier/TRP, as subsequently described.

Various methods or examples may apply to periodic Cell DTX/DRX, such as a Cell DTX/DRX operation with higher layer configured ON/OFF (or active/non-active) timer durations that repeats periodically (upon activation) or time durations that are based on timer or counter operation.

Various methods or examples may apply to non-periodic Cell DTX/DRX, such as a cell DTX/DRX operation with ON/OFF (or active/non-active) time durations that are indicated by L1/L2 signaling or such time durations that start or stop based on L1/L2 signaling without indicating a certain value, such as a certain number of symbols or slots for such time duration (i.e., until reception of next ON/OFF indication).

The embodiments may apply to any deployments, verticals, or scenarios including in FR1, FR2 (or FR2-1), FR3, FR4 (or FR2-2), with eMBB, URLLC and IIoT, mMTC and IoT including LTE NB-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Various methods and examples throughout the present disclosure are generally described without reference to an RRC state or with reference to a certain RRC state. Such methods or examples can apply to a UE in various RRC states, such as RRC Connected mode/state or to a UE in IDLE/INACTIVE mode/state or a UE performing initial/random access before camping on a cell or before establishing RRC configuration. For example, various procedures can be based on signaling from MIB or SIB such as SIB1 or other SIBx (x>1), instead of RRC configuration. For example, various procedures can be based on signaling from other higher layer signaling, such as an RRC configuration that the UE receives during RRC connection or at a time for RRC connection suspension/release before the UE transitions to RRC IDLE/INACTIVE state.

Various methods or examples are described in terms of “SSB”. Such methods or examples can apply based on any other synchronization signal, such as only PSS or only SSS or only PSS+SSS, without a broadcast channel such as PBCH, or other SSB variations in 6G radio (6GR), wherein the PSS or SSS or PBCH can be same as or different from those in 5G NR, such as with different periodicity, or different sequence generation/parameters, or different number of RBs, or different structure/patterns, and so on. Such methods or examples can apply based on other synchronization signal, such as cell-defining SSB (CD-SSB), or non-cell-defining SSB (NCD-SSB), or tracking reference signal (TRS) or discovery reference signal (DRS) or low-power synchronization signal (LP-SS), or variations or combinations thereof.

Various methods or examples are described in terms of “configuration” or “indication” or “higher layer signaling”, or variations or combinations of such terms. Such methods or example can be based on system information such as MIB/SIB/SIB1/SIBx (x>1) or based on RRC signaling, such as cell-specific RRC or UE-group-specific RRC or dedicated/UE-specific RRC, wherein such attributes can correspond to one or both of information contents of RRC message or signaling methods of the RRC message.

Various methods or examples are described in terms of “L1/L2 signaling” or “indication”, or variations or combinations of such terms. Such methods or examples can be based on signaling or indication by an L2/MAC signaling such as a MAC-CE or by an L1/PHY signaling, such as a PDCCH/DCI format that can be cell-specific or UE-group-specific or UE-specific, or such as other DL/UL channels, such as PDSCH or PUSCH or PUCCH, or such as a sequence-based signal, for example, a DL WUS/LP-WUS/DRS, that can be cell-specific or UE-group-specific or UE-specific, and so on.

Various methods or examples throughout the present disclosure are described in terms of “cell” or “cells” or variations thereof. Herein, cells can refer to one or more serving cell, or one (or more) camped cells, or one or more non-serving cells or non-camped cells, such as neighbor cells, or candidate cells, such as for inter-cell beam management procedures, or for mobility/LTM procedures, or for CSI/RRM/mobility/handover procedures, and so on. Herein, cells can include various types or functionalities of cells, such as a PCell or an SCell or a coverage cell/carrier or an anchor cell/carrier or a non-anchor cell/carrier or a capacity or date cell/carrier or a multi-carrier cell possibly over fragmented spectrum or possibly over contiguous/non-fragmented spectrum. For example, cells can include DL-only cells or UL-only cells or DL+UL cells, or cells with asymmetric or flexible DL/UL association or decoupling, such as a cell with DL receptions on a first number of frequency carriers/bands/ranges and with UL transmissions on a second number of frequency carriers/bands/ranges, and wherein such first and second number of frequency carriers/bands/ranges may be predetermined or can be configured by higher layers or can be indicated or updated by L1/L2 signaling or based on timers or counters. For example, a cell can be associated with a single TRP or multiple TRPs, such as one or multiple central units (CUs) or distributed units (DUs) or remote/radio/RF units (RUs) or antenna units (AUs), and so on. For example, various methods or examples described in terms of cells can also apply with “cell” replaced by “carrier” or “TRP” or other frequency/spatial NW entity and so on.

Various procedures or examples are described in terms of PCells. Such procedures or examples can also apply to other cells, such as SCells, PSCells, SPCells, PUCCH SCells, special SCells (sSCells), coverage cells/carriers or capacity cells/carriers. For example, a UE can have a separate DL PCell and an UL PCell that can be on different frequency carriers/bands/ranges. For example, functionalities of various cells can be predetermined in the specifications of system operation or can be configured by higher layers. For example, MIB or SIB or RRC can configured whether or not a certain method or procedure or signaling is supported on a cell. Therefore, various restrictions that a certain DL/UL signal or channel applies to only certain cells, such as only a PCell, may be void or may be predetermined in the specifications of system operation or may be enabled or disabled by higher layers or may also apply to other cells, such as SCells, possibly when enabled by higher layer signaling.

While procedures and examples in the present disclosure are described in terms of DRX such as UE DRX/UE C-DRX, various procedures and examples can also apply to other DRX or DTX operations, such as Cell DTX/DRX operation.

Various methods and examples throughout the present disclosure are described in terms of a WUS, such as a sequence-based WUS, for example, a low-power WUS (LP-WUS) based on OOK waveform or based on OFDM-overlaid OOK waveform or an OOK-overlaid OFDM waveform. Such methods and examples can apply wherein the WUS is a sequence-based DL WUS based on OFDM waveform or wherein the WUS is a channel-coding-based WUS, for example, a PDCCH-based WUS (the latter two terms, channel-coding-based WUS and PDCCH-based WUS, may be used interchangeably in the present disclosure). For example, the DL WUS can be based on a synchronization signal, such as PSS or SSS or PSS+SSS, based on 5G NR designs or other variations such as for 6GR, or can be based on other synchronization sequences or can be based on the sequences or signals, such as m-sequence, or pseudo-random sequence, or ZC sequence, or golden sequence, or other sequences. For example, DL WUS may include built-in timing, such as a sequence parameter, that indicates a time/frequency correction, such as a symbol/slot index modulo M or an RE/RB index modulo N, wherein M and NR have predetermined values or are configured by higher layers. Therefore, the UE can use such correction term to achieve finer granularity time/frequency synchronization. In another example, DL WUS can may accompany a separate synchronization signal, such as a PSS or an SSS or an SSB or an LP-SS or a TRS that is adjacent in time/frequency domain to (e.g., immediately consecutive symbols or RBs, before or after) the DL WUS, that can be TDM or FDM with the DL WUS, or possibly with a predetermined or configured time-domain or frequency domain gap. For example, the UE can receive the DL WUS together such separate synchronization signal.

When using a DL WUS/LP-WUS, information can be carried on various sequence/signal parameters, such as:
root sequence index, scrambling, randomization or hash function, amplitude/phase/frequency or corresponding offsets or shift or delay or scaling, including small shift or large shift, cyclic shift, cover code including orthogonal cover code (OCC), correlation or auto-correlation parameters such as auto-correlation zone, and so on, or
time or frequency resources or resource sets or candidate resources for such DL WUS/LP-WUS, or such as periodicity or frame/slot/symbol offset, monitoring occasions, or RB/RE level offset, for the corresponding time/frequency resources, or
power domain parameters, for example, EPRE, or relative EPRE with respect to EPRE of sync signal or of PSS/SSS or of LP-SS or of CSI-RS, and so on, or
spatial domain association for the DL WUS/LP-WUS such as spatial domain filter, or spatial filter, or same QCL assumption relative to a sync-signal index or an SSB index or an LP-SS index, or a CSI-RS or an SRS or a tracking reference signal (TRS) or a discovery reference signal (DRS), and so on.

Information contents/fields or number of information payload for LP-WUS, sequence-based DL WUS, and PDCCH-based WUS can be same in one option, while in another option different signaling mechanisms can accommodate different sizes or different fields. In addition, some (limited size) data payload may be included or multiplexed or modulated on one or more of such WUS. Such field or data can correspond to a single UE or a single cell/carrier/TRP or can correspond to multiple UEs or multiple cells/carriers/TRPs, such as separate payload/data for different cells/UEs, or a same/shared payload or data applicable to a group or sub-group of UEs or a group or sub-group of cells/carriers/TRPs.

For example, to improve UE energy efficiency, the UE may use only certain radio components, such as certain RF/baseband components, to receive the sequence-based WUS or the PDCCH-based WUS, while some other radio/RF/baseband components are switched off or operating in energy-efficient mode. For example, to improve network (NW) energy efficiency, the NW may use only certain radio components, such as certain RF/baseband components, to transmit the sequence-based WUS or the PDCCH-based WUS, while some other radio/RF/baseband components are switched off or operating in energy-efficient mode.

Various methods and examples throughout the present disclosure are described in terms of a WUS in relation with a DRX/DTX procedure, such as a UE DRX/DTX procedure or a Cell DTX/DRX procedure, for example for indicating or modifying parameters of such DTX/DRX procedures. Such methods or examples can apply wherein the WUS operates independent of such DRX/DTX procedure, for example, when start or resumption or stop or termination of various UE/cell procedures or UE/cell states is based on reception of or indication by such WUS, possibly without any DRX/DTX procedure, or in addition to or independent of such DRX/DTX procedures. Herein, UE/cell procedures can include one or more of: PDCCH monitoring or RRM measurement or CSI measurement or reporting (including CSI for link adaptation, CSI for beam management, CSI for channel/interference/mobility measurement, and so on) or SPS PDSCH reception or CG PUSCH transmission or RACH procedure or SRS transmission, and so on. Herein, UE/cell states can include cell activation or deactivation or dormancy or other high-power/performance state of UE/cell or energy-efficient state of UE/cell, and so on, wherein a state for a cell/carrier/UE can configure or indicate which signals/channels/transmissions/receptions are performed (for example, with nominal/full UE capability), or which other signals/channels/transmissions/receptions are disabled or suspended or adapted in time/frequency/spatial/power/code/sequence domains.

Various methods or examples throughout the present disclosure are described in terms of timing durations associated with a DRX procedure or timing durations associated with a PDCCH skipping procedure, such as “outside DRX active time” or “within a PDCCH skipping time duration”, and so on. Such methods or examples can apply to time durations for various other procedures or operation modes/states, for example, a time duration associated with a cell/UE with high/full power or performance operation mode or a time duration associated with a cell/UE with energy-efficient operation mode, such as a “dormancy period” or a “deactivation period” and so on. Such UE procedures or operation modes/states or associated time durations can be configured by higher layer signaling or can be indicated by L1/L2 signaling, such as a MAC-CE or a DCI or a sequence-based RS such as a WUS, or can be based on start/stop/resumption/reset/expiry of corresponding timers or counters.

Embodiments of the disclosure are summarized in the following and are fully elaborated further below. Combinations of the embodiments are also applicable but are not described in detail for brevity.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on. For example, for PUCCH transmission, one or more of 16-QAM or 64-QAM or other modulation types or modulation orders may be supported for PUCCH reception, in addition to or as an alternative for QPSK modulation. For example, for a UE in RRC_CONNECTED mode, the UE can be configured/indicated which modulation type/order to apply for a PUCCH resource or resource set, at least for dedicated PUCCH resources. For example, for a UE before RRC connection, or for a UE in IDLE/INACTIVE state operation, or for common PUCCH resources, the UE may only use QPSK for PUCCH transmission, or may be provided pre-configuration for an applicable modulation type/order, or the UE may receive a cell-specific or UE-group-specific L1/L2 signaling, such as a paging DCI format or a WUS PDCCH or a sequence-based WUS, to indicate an applicable modulation type/order.

In various methods or examples, UE DRX (or UE DRX/DTX) operation can be separate from or joint with Cell DTX/DRX operation. For example, a UE can be configured with (only) one or both of UE DRX/DTX and Cell DTX/DRX operation. For example, when a UE is configured with both UE DRX/DTX and Cell DTX/DRX operations, in a first option, the UE operates based on only one of the two procedures, such as only Cell DTX/DRX and discards the other procedure such as UE DRX/DTX procedure (or alternatively, operates based on UE DRX/DTX and ignores the Cell DTX/DRX operation configuration). In a second option, the UE operates based on both of the UE DTX/DRX operation, such as ‘union’ or ‘intersection’ of the two procedures. For example (in case of ‘union’), the UE disables or adapts signals/channels/procedures when either of UE DRX/DTX or Cell DTX/DRX indicates so, and operates without any adaptation/disabling when none of the UE DRX/DTX or Cell DTX/DRX procedures indicate such adaptation. For example (in case of ‘intersection’), the UE disables or adapts signals/channels/procedures when both of UE DRX/DTX and Cell DTX/DRX indicate so, and operates without any adaptation/disabling when at least one of the UE DRX/DTX and Cell DTX/DRX procedures do not indicate such adaptation.

For example, when UE DRX/DTX procedure configures or indicates a first level of adaptation for a signal/channel/procedure (e.g., a first periodicity, a first number of time/frequency resource, a first number of occasions/repetitions, and so on) while Cell DTX/DRX operation configures or indicates a second level of adaptation for the same signal/channel/procedures (e.g., a second periodicity, a second number of time/frequency resource, a second number of occasions/repetitions, and so on), in a first alternative, the UE applies the tighter/tightest adaptation among the first and second levels of adaptation (e.g., a longer periodicity, a smaller number of time/frequency resource, a smaller number of occasions/repetitions, a smaller number of spatial beams, a lower power level, and so on), while in a second alternative, the UE applies the looser/loosest adaptation among the first and second levels of adaptation (e.g., a shorter periodicity, a larger number of time/frequency resource, a larger number of occasions/repetitions, a larger number of spatial beams, a higher power level, and so on).

In one embodiment, during a UE/cell/carrier/TRP dormancy period or state such as outside Active time of Cell DTX (or Cell DTX/DRX), a UE can receive a WUS for example, a channel-coding-based WUS/PDCCH-based WUS, such as a DCI or a GC-DCI, or a sequence-based DL WUS such as a DL LP-WUS, that indicates whether and how the UE receives essential DL signals and channels, such as for synchronization or measurements or for acquisition of system information or paging and so on. For example, outside Active time of Cell DTX, the UE may not receive sync signal such as SS/PBCH block, or may not monitor PDCCH/PDSCH associated with Type-0/0A/1/1A/2/2A CSS sets, and the UE may use variations of a synchronization signal or the DL WUS or DL LP-WUS to establish or maintain a (coarse) DL synchronization, or to perform procedures associated with mobility/RRM/RLF, or beam management (BM)/beam failure recovery (BFR). The UE can receive indications in the DL WUS/DL LP-WUS to receive a certain number of SSB bursts/indexes that provide improved synchronization or MIB updates or certain PDCCH monitoring occasions (MOs) to monitor and receive PDCCH for Type-0/0A/1/1A CSS sets that provides SIB updates or paging information. The UE can continue an ongoing Cell DTX cycle after reception of the indicated SSBs or Type-0/0A/2/2A PDCCHs. Alternatively, upon reception of DL WUS or LP-WUS, the UE can terminate the ongoing Cell DTX cycle such as the non-Active time and start a next Cell DTX cycle. Various methods are also applicable to Type-1/1A CSS set (for RAR or MsgB reception), or to RRM, RLF and BFR, or for small data transmission (SDT).

In one variation, the UE can be predetermined or configured to monitor DL WUS (such as PDCCH-based WUS or GC-DCI, or such as sequence-based DL WUS/LP-WUS) only during non-active of Cell DTX/DRX. When the UE switches to the active time of Cell DTX/DRX, the stops/suspends monitoring of DL WUS. In another variation, the UE can be predetermined or configured to monitor DL WUS also during active time of Cell DTX/DRX, wherein the DL WUS can provide indication of go-to-sleep or can provide other indications, such as switching operation state of the cell/carrier/TRP or for indication of activation/deactivation/dormancy or fast ON/OFF for cells/carriers/TRPs, or for update of Cell DTX/DRX parameters, or start or stop of Cell DTX/DRX procedure or start or stop of Cell DTX/DRX cycle (e.g., active time or non-active time), or for indication of applicable SSSG or for update of CORESET parameters, and so on.

In one embodiment, outside Active time of Cell DRX, a UE can transmit an UL WUS (e.g., UL LP-WUS) to request for immediate termination of an ongoing Cell DRX cycle or for fast deactivation of the Cell DRX configuration for one or more cells. The UE applies such termination/deactivation of Cell DRX after receiving a positive confirmation/indication from the gNB, for example, in a DL WUS/DL LP-WUS or as a system information update, or possibly also for paging or RAR. The UL WUS can be a low-power/power-efficient signal or channel for one or both of the gNB and the UE. Various methods may consider low-power receiver (LP-WUR or simply LR) or low-power transmit radio at the gNB side, in addition to or instead of the UE side. Similar methods apply for UE-initiated or UE-based starting or stopping of PDCCH monitoring or other UE procedures, such as by using UL WUS or UL LP-WUS, for example, in case of UE C-DRX or apply to PDCCH skipping instead of or in addition to Cell DTX/DRX.

In one embodiment, the specification of system operations, higher layer signaling, or a DCI format (e.g., 2_9) or a DL WUS/LP-WUS for Cell DTX/DRX configuration/activation can indicate that various DL/UL signals or channels are disabled or adapted in time/frequency/spatial/power/code/sequence domain outside Active time of Cell DTX/DRX, such as CSI-RS or SRS or unicast PDCCH or PUCCH. The UE may not perform UE procedures associated with such disabled or adapted DL/UL signals or channels, such as measurements or time/frequency synchronization or tracking, or the UE may perform corresponding UE procedures using alternative DL/UL signals or channels, such as SSB or LP-SS or DL WUS such as DL LP-WUS (that are QCL with a disabled CSI-RS or SRS) or PRACH.

In one embodiment, for fast adaptation of Cell DTX/DRX, a UE can receive a field/information in a DCI format (e.g., 2_9) for activation of Cell DTX/DRX or in a DL LP-WUS that indicates to a UE value, from multiple configured values, for one or more of the Cell DTX/DRX parameters, such as ON duration or cycle length, or indicates to the UE an index of a configuration or sub-configuration, from multiple configurations or sub-configurations, for Cell DTX/DRX. The indication in the DCI format (e.g., 2_9) or the indication by the DL WUS/DL LP-WUS can be applicable within or outside Active time of Cell DTX/DRX.

In one embodiment, a UE can be configured a number of one or more cell groups for Cell DTX/DRX operation, wherein same parameters, such as same ON timer and same cycle length, or same indications, such as for Cell DTX/DRX activation or deactivation, apply to different cells in the cell group. Alternatively, each cell in the cell group can operate with separate parameters, while the UE determines an Active time for Cell DTX/DRX jointly across different cells of the cell group.

In one embodiment, a UE can be configured LP-WUS on a first cell, such as an FR1 PCell, that indicates Cell DTX/DRX or wake-up/no-wake-up for PDCCH monitoring or disabling or enabling other UE procedures such as CSI/RRM measurements on a second cell or a group of second cells, such as FR2 or FR3 SCells. Similar, an LP-SS or DL WUS on the first cell can be used for UE procedures that are based on SSB on the second cell or the group of second cells, thereby facilitating a disabling of SSB on the second cell. For example, the UE can receive the DL WUS/LP-WUS on a first cell, wherein the wake-up or switching to active time can apply to a number of second cells, wherein the number of second cells can include the first cell, or may not include the first cell. For example, the first cell can be on a first frequency carrier/band/range, and the number of second cells can be on the same (i.e., first) frequency carrier/band/range, or some or all cells from the number of second cells can be on a second/different frequency carrier/band/range. For example, the first cell can be on FR1, while (at least some of) the number of second cells are on FR2 or FR3.

In one embodiment, a UE in non-active time of Cell DTX/DRX can receive reference signal (RS), such as on-demand or aperiodic RS, for example, OD-SSB or aperiodic TRS/CSI-RS, to assist with switching to active time of Cell DTX/DRX, such as fast or energy-efficient wake-up. The UE and/or gNB may operate with a first radio (e.g., low-power radio or LR) or with a first set (with reduced number) of radio components/RF chains/antenna elements during non-active time, and the UE and/or gNB may operate with a second radio (e.g., a main radio or MR) or with a second set (with increased or maximum number) of radio components/RF chains/antenna elements during active time. The first set can be a subset of the second set. The OD-RS or ap-RS can assist the UE/gNB with fast wake-up of the second radio or the second set of radio components/RF chains/antennas by providing early RS reception or measurements. Such early RS can be triggered by L1/L2 signaling such as a DL WUS or a GC-DCI, such as one that triggers a termination of non-active time and start of the active time of Cell DTX/DRX. For example, the UE can receive such OD-SSB or aperiodic TRS or CSI-RS prior or start of the active time (by the first radio or the first radio components) or after the start of the active time (by the second radio or the second radio components), and a time offset for reception of the OD-SSB or aperiodic TRS or CSI-RS relative to reception the trigger (e.g., the DL WUS) can be based on an application time configured by higher layers or can be based on a UE capability or can be indicated by L1/L2 signaling, such as the same L1/L2 signaling. In the following, unless otherwise noted, providing a parameter value by higher layers includes providing the parameter value by MIB or a system information block (SIB), such as a SIB1, or by a common RRC signaling, or by UE-specific RRC signaling.

In the following, unless otherwise noted, a parameter referenced in italics is provided by higher layers such as by SIB or RRC.

A set of PDCCH candidates for a UE to monitor is defined in terms of PDCCH search space sets. A search space set can be a CSS set or a USS set.

For each DL BWP configured to a UE in a serving cell, the UE can be provided by higher layer signaling with
P≤3 CORESETs if coresetPoolIndex is not provided, or if a value of coresetPoolIndex is same for CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetId or by controlResourceSetId-v1610, where
   0<p<12 if coresetPoolIndex is not provided, or if a value of coresetPoolIndex is same for CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGranularity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect
to be configured a set of resource blocks of a CORESET that includes more than four sub-sets of resource blocks that are not contiguous in frequency
any RE of a CORESET to overlap with any RE determined from
   lte-CRS-ToMatchAround or LTE-CRS-PatternList, if the UE is not provided pdcchCandidateReception-WithCRSOverlap, or
   a SS/PBCH block.

For each DL BWP configured to a UE in a serving cell, the UE is provided by higher layers with S≤10 search space sets where, for each search space set from the S search space sets, the UE is provided the following by SearchSpace:
a search space set index s, 0<s<40, by searchSpaceId
an association between the search space set s and a CORESET p by controlResourceSetId or by controlResourceSetId-v1610
a PDCCH monitoring periodicity of kₛ slots and a PDCCH monitoring offset of oₛ slots, by monitoringSlotPeriodicityAndOffset or by monitoringSlotPeriodicityAndOffset-r17
a PDCCH monitoring pattern within a slot, indicating first symbol(s) of the CORESET for PDCCH monitoring within each slot where the UE monitors PDCCH, by monitoringSymbolsWithinSlot
a duration of Tₛ<kₛ indicating a number of slots that the search space set s exists by duration, or a number of slots in consecutive groups of slots where the search space set s can exist by duration-r17
a bitmap, by monitoringSlotsWithinSlotGroup, that applies per group of slots and provides a PDCCH monitoring pattern indicating slots in a group of slots for PDCCH monitoring
   a size of the group of slots is same as a size of monitoringSlotsWithinSlotGroup
   for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ
   for a Type1-PDCCH CSS set provided by ra-SearchSpace in SIB1, the PDCCH monitoring pattern indicates only up to 1 slot in the group of slots for PDCCH monitoring
   for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlotsWithinSlotGroup
a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively
an indication that search space set s is either a CSS set or a USS set by searchSpaceType
if search space set s is a CSS set
   an indication by dci-Format0-0-AndFormat1-0 to monitor PDCCH candidates for DCI format 0_0 and DCI format 1_0
   an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level
   an indication by dci-Format2-1 to monitor PDCCH candidates for DCI format 2_1
   an indication by dci-Format2-2 to monitor PDCCH candidates for DCI format 2_2
   an indication by dci-Format2-3 to monitor PDCCH candidates for DCI format 2_3
   an indication by dci-Format2-4 to monitor PDCCH candidates for DCI format 2_4
   an indication by dci-Format2-6 to monitor PDCCH candidates for DCI format 2_6
   an indication by dci-Format2-9 to monitor PDCCH candidates for DCI format 2_9
   an indication by dci-Format4-0 to monitor PDCCH candidates for DCI format 4_0
   an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively
an indication by searchSpaceLinkingId that search space set s is linked to another search space set for which is provided a same value for searchSpaceLinkingId
if search space set s is a USS set,
   an indication by dci-Formats to monitor PDCCH candidates either for DCI format 0_0 and DCI format 1_0, or for DCI format 0_1 and DCI format 1_1, or
   an indication by dci-FormatsExt to monitor PDCCH candidates for DCI format 0_2 and DCI format 1_2, or for DCI format 0_1, DCI format 1_1, DCI format 0_2, and DCI format 1_2, or
   an indication by dci-FormatsMC to monitor PDCCH candidates for one or both of DCI format 0_3 and DCI format 1_3, or
   an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8
a bitmap by freqMonitorLocations, if provided, to indicate an index of one or more RB sets for the search space set s, where the most significant bit (MSB) k in the bitmap corresponds to RB set k−1 in the DL BWP. For RB set k indicated in the bitmap, the first PRB of the frequency domain monitoring location confined within the RB set is given by

$$R {B}_{s 0 + k , DL}^{start , μ} + {N}_{RB}^{offset} ,$$

where

$$R {B}_{s 0 + k , DL}^{start , μ}$$

is the index of first common RB of the RB set k [6, TS 38.214], and

$${N}_{RB}^{offset}$$

is provided by rb-Offset or

$${N}_{RB}^{offset} = 0$$

if rb-Offset is not provided. For each RB set with a corresponding value of 1 in the bitmap, the frequency domain resource allocation pattern for the monitoring location is determined based on the first

$${N}_{RBG , set 0}^{size}$$

bits in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for search space sets, the UE does not expect to be configured with a PDCCH SCS other than 15 kHz if the subset includes at least one symbol after the third symbol.

A UE does not expect to be provided a first symbol and a number of consecutive symbols for a CORESET that results to a PDCCH candidate mapping to symbols of different slots.

A UE does not expect any two PDCCH monitoring occasions on an active DL BWP, for a same search space set or for different search space sets, in a same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

[4, TS 38.211] in a frame with number n_{f} if

$$( {n}_{f} {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ−Tₛ consecutive slots. If monitoringSlotsWithinSlotGroup is provided, for search space set s, the UE determines that the slot with number

$${n}_{s , f}^{μ}$$

[4, TS 38.211] in a frame with number n_{f} satisfying

$$( {n}_{f} {N}_{slot}^{frame , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlotsWithinSlotGroup, starting from slot

$${n}_{s , f}^{μ} ,$$

and does not monitor PDCCH candidates for search space set s for the next kₛ−Tₛ consecutive slots.

A USS at CCE aggregation level L∈{1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in a USS, if the UE is not configured with a carrier indicator field, the UE monitors the PDCCH candidates without carrier indicator field. For an active DL BWP of a serving cell on which a UE monitors PDCCH candidates in a USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{{p}_{,} {n}_{s f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where
for any CSS,

$${Y}_{p , {n}_{s , f}^{μ}} = 0 ;$$

for a USS,

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per RB set
   for CORESET 0, the CCEs are obtained prior to puncturing, if any, of corresponding RBs [4, TS 38.211];
n_{CI} is
   the carrier indicator field value, if provided by cif-InSchedulingCell in CrossCarrierSchedulingConfig for the serving cell on which PDCCH is monitored, except for scheduling of the serving cell from the same serving cell in which case n_{CI}=0;
   the nCI-Value provided for the set of serving cells MC-DCI-SetofCells, if MC-DCI-SetofCells is provided;
   otherwise, including for any CSS, n_{CI}=0

$${m}_{s , {n}_{CI}}^{( L )} = 0 , ⋯ , {M}_{s , {n}_{CI}}^{( L )} - 1 ,$$

where

$${M}_{s , {n}_{CI}}^{( L )}$$

is the number of PDCCH candidates the UE is configured to monitor for aggregation level L of a search space set s for a serving cell corresponding to n_{CI};
for any CSS,

$${M}_{s , max}^{( L )} = {M}_{s , 0}^{( L )} ;$$

for a USS,

$${M}_{s , max}^{( L )}$$

is the maximum of

$${M}_{s , {n}_{CI}}^{( L )}$$

over configured n_{CI} values for a CCE aggregation level L of search space set s;
the RNTI value used for n_{RNTI} is the cell-radio network temporary identifier (C-RNTI).

For search space sets sᵢ and sⱼ that include searchSpaceLinkingId with same value, a UE monitors, in monitoring occasions with same index according to each of search space sets sᵢ and sⱼ in a slot, PDCCH candidates

$${m}_{{s}_{i} , {n}_{CI}}^{( L )} and {m}_{{s}_{j} , {n}_{CI}}^{( L )} ,$$

with

$${m}_{{s}_{i} , {n}_{CI}}^{( L )} = {m}_{{s}_{j} , {n}_{CI}}^{( L )} ,$$

for detection of a DCI format with same information. The UE expects kₛ_{ᵢ}=kₛ_{ⱼ}, oₛ_{ᵢ}=oₛ_{ⱼ}, Tₛ_{ᵢ}=Tₛ_{ⱼ},

$${M}_{{s}_{i}}^{( L )} = {M}_{{s}_{j}}^{( L )} ,$$

and a same number of non-overlapping PDCCH monitoring occasions per slot based on corresponding monitoringSymbolsWithinSlot, for search space sets sᵢ and sⱼ. For CORESET pᵢ associated with the search space set sᵢ and for CORESET pⱼ associated with the search space set sⱼ, the UE is provided tci-PresentInDCI or tci-PresentDCI-1-2 for either none or both of CORESETs pᵢ and pⱼ. For CORESET pᵢ associated with the search space set sᵢ and for CORESET pⱼ associated with the search space set sⱼ, the UE is either not provided coresetPoolIndex value of 1 for any of the two CORESETs, or is provided coresetPoolIndex value of 1 for both CORESETs.

A UE can indicate by numBD-twoPDCCH-r17 a capability for counting PDCCH candidates

$${m}_{{s}_{i} , {n}_{CI}}^{( L )} and {m}_{{s}_{j} , {n}_{CI}}^{( L )}$$

either as 2 PDCCH candidates or as 3 PDCCH candidates.

A UE expects to monitor PDCCH candidates for up to 4 sizes of DCI formats that include up to 3 sizes of DCI formats with CRC scrambled by C-RNTI per serving cell. The UE counts a number of sizes for DCI formats per serving cell based on a number of configured PDCCH candidates in respective search space sets for the corresponding active DL BWP.

A UE does not expect to detect, in a same PDCCH monitoring occasion, a DCI format with CRC scrambled by a system information (SI-RNTI), random access RNTI (RA-RNTI), MsgB-RNTI, temporary cell RNTI (TC-RNTI), P-RNTI, C-RNTI, configured scheduling RNTI (CS-RNTI), modulation and coding scheme RNTI (MCS-RNTI), multicast control channel RNTI (MCCH-RNTI), group RNTI (G-RNTI), G-CS-RNTI, or multicast-MCCH-RNTI and a DCI format with CRC scrambled by a sidelink RNTI (SL-RNTI) or a SL-CS-RNTI for scheduling respective PDSCH reception and physical sidelink shared channel (PSSCH) transmission on a same serving cell.

DL transmissions or UL transmissions can be based on an orthogonal frequency division multiplexing (OFDM) waveform including a variant using DFT precoding that is known as DFT-spread-OFDM (see also REF 1).

A UE typically monitors multiple candidate locations for respective potential PDCCH receptions to decode one or more DCI formats in a slot, for example as described in REF 3. A DCI format includes cyclic redundancy check (CRC) bits in order for the UE to confirm a correct detection of the DCI format. A DCI format type is identified by a radio network temporary identifier (RNTI) that scrambles the CRC bits (see also REF 2). For a DCI format scheduling a PDSCH or a PUSCH to a single UE, the RNTI can be a cell RNTI (C-RNTI) and serves as a UE identifier. For a DCI format scheduling a PDSCH conveying system information (SI), the RNTI can be a SI-RNTI. For a DCI format scheduling a PDSCH providing a random access response (RAR), the RNTI can be a RA-RNTI. For a DCI format providing transmit power control (TPC) commands to a group of UEs, the RNTI can be a TPC-RNTI. Each RNTI type can be configured to a UE through higher-layer signaling such as RRC signaling (see also REF 5). A DCI format scheduling PDSCH transmission to a UE is also referred to as DL DCI format or DL assignment while a DCI format scheduling PUSCH transmission from a UE is also referred to as UL DCI format or UL grant.

A PDCCH transmission can be within a set of PRBs. A gNB (e.g., the BS 102) can configure a UE one or more sets of PRB sets, also referred to as control resource sets (CORESETs), for PDCCH receptions (see also REF 3). A PDCCH transmission can be in control channel elements (CCEs) of a CORESET. A UE determines CCEs for a PDCCH reception based on a search space set (see also REF 3). A set of CCEs that can be used for PDCCH reception by a UE define a PDCCH candidate location.

The PDCCH monitoring activity of the UE in RRC connected mode is governed by DRX, BA, DCP and cell DTX.

When DRX is configured, the UE does not have to continuously monitor PDCCH. DRX is characterized by the following:
on-duration: duration that the UE waits for, after waking up, to receive PDCCHs. If the UE successfully decodes a PDCCH, the UE stays awake and starts the inactivity timer;
inactivity-timer: duration that the UE waits to successfully decode a PDCCH, from the last successful decoding of a PDCCH, failing which it can go back to sleep. The UE shall restart the inactivity timer following a single successful decoding of a PDCCH for a first transmission only (i.e., not for retransmissions);
retransmission-timer: duration until a retransmission can be expected;
LP-WUS/DL WUS PDCCH monitoring timer: duration that the UE waits for, after woken up by LP-WUS/DL WUS, to receive PDCCH. In case this timer is configured the UE does not start the on-duration timer. If the UE successfully decodes a PDCCH, the UE stays awake and starts the inactivity timer;
cycle: specifies the periodic repetition of the on-duration followed by a possible period of inactivity;
active-time: total duration that the UE monitors PDCCH. This includes the “on-duration” of the DRX cycle, the time UE is performing continuous reception while the inactivity timer has not expired, the time when the UE is performing continuous reception while waiting for a retransmission opportunity, and the time UE is performing continuous reception while the LP-WUS PDCCH monitoring timer has not expired.

A UE can be configured with LP-WUS for power saving in all RRC states. A LP-WUS is transmitted based on OOK and overlaid OFDM sequence(s) over OOK ON symbols and can carry up to 5 information bits and one codepoint out of up to 32 codepoints. A UE supports detection of LP-WUS information carried by OOK and/or overlaid OFDM sequences. In RRC_IDLE and RRC_INACTIVE, the same information is delivered by OOK and overlaid OFDM sequences. For LP-WUS, the number of OOK symbols within an OFDM symbol can be configured as 1, 2 or 4. For RRC_IDLE and RRC_INACTIVE, a UE monitors two codepoints for LP-WUS. In RRC_CONNECTED, a UE can be configured to monitor up to 8 codepoints for LP-WUS. In various example, an LP-WUS/DL WUS can support larger number of codepoints or larger information payload.

When BA is configured, the UE only has to monitor PDCCH on the one active BWP i.e., it does not have to monitor PDCCH on the entire DL frequency of the cell. A BWP inactivity timer (independent from the DRX inactivity-timer described above) is used to switch the active BWP to the default one: the timer is restarted upon successful PDCCH decoding and the switch to the default BWP takes place when it expires.

In addition, the UE may be indicated, when configured accordingly, whether it is required to monitor or not the PDCCH during the next occurrence of the on-duration by a DCP monitored on the active BWP. If the UE does not detect a DCP on the active BWP, it does not monitor the PDCCH during the next occurrence of the on-duration, unless it is explicitly configured to do so in that case.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when it monitors response for a CFRA preamble transmission for beam failure recovery, in which case it monitors the PDCCH during the next on-duration. If no DCP is configured in the active BWP, UE follows normal DRX operation.

When CA is configured, DCP or LP-WUS/DL WUS is only configured on the PCell.

One DCP can be configured to control PDCCH monitoring during on-duration for one or more UEs independently.

Power saving in RRC_IDLE and RRC_INACTIVE can also be achieved by UE relaxing neighbor cells RRM measurements when it meets the criteria determining it is in low mobility and/or not at cell edge. When UE is configured with both high speed measurements and RRM measurement relaxation as specified in TS 38.331, it is up to UE implementation whether to apply the FR1 high speed RRM requirements or the relaxed RRM requirements when the low mobility related criterion is configured and fulfilled as specified in TS 38.133.

Power saving in RRC_IDLE and RRC_INACTIVE can also be achieved by allowing UEs supporting LP-WUS to relax serving cell measurements on MR, further relax neighbor cell measurements on MR and/or offload serving cell measurements from MR to LR. Conditions for further relax neighbor and serving cell measurements are based on MR and optionally LR measurements as specified in TS 38.304. Entry condition for offloading serving cell measurements from MR to LR is based on MR and optionally LR measurements as specified in TS 38.304 [10]. Exit conditions for offloading serving cell measurements from MR to LR are based on LR measurements as specified in TS 38.304 [10].

For UE in RRC_IDLE and RRC_INACTIVE configured with LP-WUS, LP-SS is supported for UE LR to maintain synchronization and perform serving cell RRM measurements. LP-SS transmission is based on OOK with or without overlaid OFDM sequence. For UE capable of detecting overlaid OFDM sequence by LR, PSS/SSS can be used for UE LR to maintain synchronization and perform serving cell RRM measurements. For LP-SS, the number of OOK symbols within an OFDM symbol can be configured as 1, 2 or 4 and the number can be same or larger than LP-WUS. LP-SS is not supported in RRC_CONNECTED.

For UE in RRC_IDLE and RRC_INACTIVE configured with LP-WUS, the frequency resource of LP-WUS and LP-SS can be configured within or outside the initial DL BWP in the carrier where the UE monitors paging. For UE in RRC_CONNECTED, the frequency resource of LP-WUS can be configured within or outside the UE active DL BWP, where the support of LP-WUS monitoring outside active DL BWP is optional.

For UE in RRC_IDLE and RRC_INACTIVE configured with LP-WUS, three candidate values for wake-up delay are supported for UE to report via capability signaling, where wake-up delay is defined as the minimum time gap between the LP-WUS reception and MR to start PDCCH monitoring. A gNB can configure one or two time-offset values between the reference PF of the PO and the associated LP-WUS monitoring occasions. If at least one of the configured time offset values are no smaller than the wake-up delay that UE reports, the UE monitors LP-WUS monitoring occasions corresponding to the smallest time offset value that is no smaller than its reported wake-up delay, otherwise, the UE does not monitor LP-WUS and monitors PO.

UE is not required to support simultaneous reception using LR and MR, where LR is used for LP-WUS monitoring and MR is used for transmission and/or reception of all other NR signals/channels in RRC_CONNECTED within the same cell group.

It is up to UE implementation to implement LR in the same or different physical receiver as MR.

A UE configured with DRX mode operation and operating in the RRC_IDLE or RRC_INACTIVE state can be provided for LPSS/WUS reception
a number of OOK symbols per OFDM symbol, a first RB, and an overlaid OFDM sequence per OOK symbol for LPSS reception, and an EPRE ratio relative to SS/PBCH blocks, and
a number of OOK symbols per OFDM symbol, the first RB, and one or more overlaid OFDM sequences per OOK symbol for WUS reception, and an EPRE ratio relative to SS/PBCH blocks.

A UE assumes that an SCS configuration for LPSS/WUS receptions is same as an SCS of the initial DL BWP and an SCS configuration of an SS/PBCH block the UE used to obtain SIB1.

A UE receives an LPSS in consecutive symbols within a slot. The UE can be provided one or two first symbols for respective one or two LPSS reception occasions in the slot by lpss-StartSymbol. The UE determines slots for LPSS reception occasions based on a periodicity and a time offset, relative to a system frame with SFN 0, provided by lpss-periodicityoffset. Within a period of LPSS reception occasions, LPSS reception occasions are in a set of ┌K/L┐ consecutive slots that have all symbols indicated as downlink by tdd-UL-DL-ConfigurationCommon, if provided, and start from the first slot provided by the time offset in the period, where K is the number of transmitted SS/PBCH blocks indicated by ssb-PositionsInBurst in SIB1 and L is the number of LPSS reception occasions in a slot.

LPSS reception occasions are indexed sequentially in time. An LPSS reception at the k-th LPSS reception occasion is quasi co-located with the k-th transmitted SS/PBCH block, with respect to quasi co-location ‘typeC’ or ‘typeD’ properties when applicable, where 1≤k≤K.

If a UE is provided wus-LPSS-beamSubset, the UE receives LPSS/WUS based on the quasi co-location properties of transmitted SS/PBCH blocks indicated by wus-LPSS-beamSubset; otherwise, the UE receives LPSS/WUS based on the quasi co-location properties for transmitted SS/PBCH blocks indicated by ssb-PositionsInBurst in SIB1. A WUS occasion includes K·M WUS monitoring occasions that are indexed sequentially in time, where
K is the number of transmitted SS/PBCH blocks indicated by ssb-PositionsInBurst in SIB1, M is a number of WUS monitoring occasions associated with each of the K transmitted SS/PBCH blocks provided by MONumperLO, and
a WUS monitoring occasion with index (k−1)·M+m, where 1≤m≤M and 1≤k≤K, is quasi co-located with the k-th transmitted SS/PBCH block with respect to quasi co-location ‘typeC’ or ‘typeD’ properties, when applicable

A UE can be provided, by WUS_available_slot_IDLE/INACTIVE, a bitmap that corresponds to a set of time units that repeats continuously and indicates a subset of time units from the set of time units that is available for the UE to monitor WUS. A time unit includes one slot or two slots. The UE can be additionally provided, by WUS_available_symbol_IDLE/INACTIVE, an indication of symbols in each time unit from the subset of time units that is available for the UE to monitor WUS. If the UE is not provided WUS_available_slot_IDLE/INACTIVE, the UE assumes that all time units are available for the UE to monitor WUS. If the UE is not provided WUS_available_symbol_IDLE/INACTIVE, the UE assumes that, for a time unit that is available for the UE to monitor WUS, all symbols in the time unit are available for the UE to monitor WUS. The UE assumes that a symbol is not available to monitor WUS when
the symbol is indicated as uplink, by tdd-UL-DL-configurationCommon
the symbol is indicated for an SS/PBCH block transmission, by ssb-PositionsInBurst in SIB1, and the SS/PBCH block transmission would overlap in frequency with the WUS transmission
the symbol is indicated for PDCCH transmissions, by pdcch-ConfigSIB1, and CORESET 0 for the PDCCH transmissions would overlap in frequency with the WUS transmission

A WUS monitoring occasion is over a first number of symbols, provided by WUS_NominalMO_duration_IDLE/INACTIVE. If a number of available symbols for the UE to monitor WUS in a WUS monitoring occasion is smaller than a second number of symbols provided by WUS_ActualMO_duration_IDLE/INACTIVE, the UE does not monitor WUS in the WUS monitoring occasion. The UE monitors WUS in a WUS monitoring occasion over the earliest available WUS_ActualMO_duration_IDLE/INACTIVE symbols in the WUS monitoring occasion. If a number of available symbols for the UE to monitor WUS in a WUS monitoring occasion includes a symbol for LPSS reception, the UE does not monitor WUS in the WUS monitoring occasion.

A UE assumes that WUS occasions occur with a periodicity equal to the I-DRX cycle in the RRC_IDLE/RRC_INACTIVE state. The UE determines WUS occasions associated with a paging occasion based on PO-to-LO association. A reference frame of a WUS occasion starts a number of frames prior to the first of a number of paging frames associated with the WUS occasion. Each number of frames is provided by LO-FrameOffsets. The first WUS monitoring occasion of a WUS occasion starts at an offset provided by offset_firstMO_withinLO relative to the start of the reference frame. If multiple values for the number of frames provided by LO-FrameOffsets are larger than or equal to the value of a higher layer parameter XYZ, the UE monitors WUS starting at a WUS occasion corresponding to the smallest of the multiple values. If all values for the number of frames provided by LO-FrameOffsets are smaller than the value of XYZ, the UE monitors PDCCH according to Type2-PDCCH CSS sets associated with the paging occasion and does not monitor WUS.

A paging occasion associated with a WUS occasion has index

$${i}_{PO} = ( ( UE\_ID mod N ) \cdot {N}_{S} + i\_s ) mod {N}_{PO}^{WO}$$

where

$${N}_{PO}^{WO}$$

is a number of paging occasions associated with a WUS occasion, N, N_{S}, i_{SG}, and i_s are defined in TS 38.304, and UE_ID is defined in clause 7.1 of TS 38.304. If a number of

$${N}_{SG}^{PO}$$

subgroups per paging occasion, provided by subgroupNumber-PO-WUS, is

$${N}_{SG}^{PO} > 1 ,$$

the codepoint for the subgroup index i_{SG} in a PO i_{PO} is

$${i}_{PO} * ( {N}_{SG}^{PO} + 1 ) + {i}_{SG} ,$$

and the codepoint for all subgroups in the PO is

$$( {i}_{PO} + 1 ) * ( {N}_{SG}^{PO} + 1 ) - 1 ;$$

otherwise, the codepoint for the PO i_{PO} is i_{PO}.

If, in a WUS monitoring occasion, a UE determines a codepoint associated with the UE, the UE performs PDCCH monitoring according to Type2-PDCCH CSS sets for the paging occasion associated with the WUS monitoring occasion when a time from the end of the WUS reception to the start of the PDCCH monitoring occasion is not smaller than the value of XYZ; otherwise, the UE is not required to perform the PDCCH monitoring. The UE may also perform PDCCH monitoring for Type2A-PDCCH CSS sets for DCI format 2_7, if provided.

A UE configured with DRX mode operation and operating in the RRC_CONNECTED state can be provided for WUS reception on the primary cell of a cell group
a number of OOK symbols per OFDM symbol, a first RB, and overlaid OFDM sequences per OOK symbol for WUS reception, and
a number of codepoints provided for the UE by the WUS, by WUS-codepointCONNECTED

A UE assumes that a WUS is quasi co-located with an SS/PBCH block or a CSI-RS with respect to quasi co-location ‘typeC’ or ‘typeD’ properties, when applicable.

If a UE is provided ABC, the UE receives WUS based on the quasi co-location information of the TCI states indicated by a most recent DCI format or MAC CE, after a respective application time; otherwise, the UE receives WUS based on the quasi co-location information of the TCI states for a CORESET with controlResourceSetId value that is same as the one indicated by WUS_TCI_states_CONNECTED.

A UE assumes that an SCS configuration for WUS receptions is same as an SCS configuration for the active DL BWP.

A UE does not monitor a WUS during Active Time.

A UE does not monitor WUS during DTX inactive period for the primary cell.

A UE can be provided by WUS-MOCONNECTED-Option 1-1 a periodicity, by periodicityMO-Option 1-1, and a time offset, by offsetMO-Option 1-1, relative to the start of a system frame with SFN 0, for the UE to determine WUS monitoring occasions. The UE starts to monitor WUS in a first WUS monitoring occasion that is not earlier than a first slot that is prior to a second slot where the drx-onDurationTimer would start by a time provided by timeOffsetCONNECTEDOption 1-1, and monitors WUS for a number of monitoring occasions provided by numMO-Option 1-1. The UE reports a number of slots where the UE is not required to monitor WUS prior to the slot where the drx-onDurationTimer would start. The UE is not required to monitor WUS within the reported number of slots prior to the slot where the drx-onDurationTimer would start. If the UE determines to monitor PDCCH based on a detected WUS, the UE starts the drx-onDurationTimer.

A UE can be provided by WUS-MOCONNECTED-Option 1-2 a periodicity, by periodicityMO-Option 1-2, and a time offset, by offsetMO-Option 1-2, relative to the start of a system frame with SFN 0, for the UE to determine first WUS monitoring occasions from a number of WUS monitoring occasions per periodicity, provided by numMO-perPeriodicity-Option 1-2. The UE reports a number of slots and expects that a time gap, from a last WUS monitoring occasion from the number of WUS monitoring occasions per periodicity to the slot where the wus-PDCCHMonitoringTimer would start, is no smaller than the reported number of slots. If the UE determines to monitor PDCCH based on a detected WUS, the UE starts wus-PDCCHMonitoringTimer after a time, provided by timeOffsetCONNECTEDOption 1-2, with respect to the start of the first WUS monitoring occasion from the number of WUS monitoring occasions per periodicity.

A UE can be provided, by WUS_available_slot_CONNECTED, a bitmap that corresponds to a set of time units that repeats continuously and indicates a subset of time units from the set of time units that is available for the UE to monitor WUS [12, TS 38.331]. A time unit includes one slot or two slots. The UE can be additionally provided, by WUS_available_symbol_CONNECTED, an indication of symbols in each time unit from the subset of time units that is available for the UE to monitor WUS. If the UE is not provided WUS_available_slot_CONNECTED, the UE assumes that all time units are available for the UE to monitor WUS. If the UE is not provided WUS_available_symbol_CONNECTED, the UE assumes that, for a time unit that is available for the UE to monitor WUS, all symbols in the time unit are available for the UE to monitor WUS. The UE assumes that a symbol is not available to monitor WUS when
the symbol is indicated as uplink, by tdd-UL-DL-configurationCommon or tdd-UL-DL-ConfigurationDedicated
the symbol is indicated for transmission of SS/PBCH blocks, by ssb-PositionsInBurst in SIB1 or in ServingCellConfigCommon

A WUS monitoring occasion is over a first number of symbols, provided by WUS_NominalMO_duration_CONNECTED. If a number of available symbols for the UE to monitor WUS in a WUS monitoring occasion is smaller than a second number of symbols, provided by WUS_ActualMO_duration_CONNECTED, the UE does not monitor WUS in the WUS monitoring occasion. The UE monitors WUS in a WUS monitoring occasion over the earliest available WUS_ActualMO_duration_CONNECTED symbols in the WUS monitoring occasion.

If a UE detects a codepoint in a WUS reception, from the number of codepoints, on the primary cell of the cell group, the UE starts monitoring PDCCH on all applicable serving cells of the cell group.

UE power saving may be enabled by adapting the DL maximum number of MIMO layers by BWP switching.

Power saving is also enabled during active-time via cross-slot scheduling, which facilitates UE to achieve power saving with the assumption that it won't be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are on-duration and inactivity-timer.

A UE configured with DRX in RRC_CONNECTED can be configured with LP-WUS. LP-WUS is monitored outside active-time. If LP-WUS is detected, the UE shall start the on-duration timer or LP-WUS PDCCH monitoring timer to start PDCCH monitoring and enter active-time:
If the UE is configured to start on-duration timer after LP-WUS reception, the UE monitors LP-WUS at occasion(s) at a configured offset before the on-duration, and the UE does not monitor LP-WUS when short DRX cycle is used. If the UE is unable to monitor the LP-WUS occasion, it shall start the on-duration timer.
If the UE is configured to start LP-WUS PDCCH monitoring timer after LP-WUS reception, the UE monitors LP-WUS at occasion(s) according to the configured periodicity and offset which can be same or different from the periodicity and offset configured for C-DRX cycle, and the UE monitors LP-WUS regardless of which DRX cycle is used. It the UE is unable to monitor the LP-WUS occasion(s), the LP-WUS PDCCH monitoring timer is not started.

Three candidate values for minimum time gap are supported for UE in RRC_CONNECTED to report via capability signaling, where the minimum time gap is between the LP-WUS reception and MR to start PDCCH monitoring. gNB configures the time offset between LP-WUS monitoring and the corresponding PDCCH monitoring.

When LP-WUS is configured, the next available uplink resources determined by the MAC entity (e.g. PUCCH resource for SR, PRACH occasion, and CG resource) occur when MR is activated.

UE power saving in RRC_IDLE/RRC_INACTIVE may be achieved by providing the configuration for TRS with CSIRS for tracking in TRS occasions. The TRS in TRS occasions may allow UEs in RRC_IDLE/RRC_INACTIVE to sleep longer before waking-up for its paging occasion. The TRS occasions configuration is provided in either SIB17 or SIB17bis. The availability of TRS in the TRS occasions is indicated by L1 availability indication. These TRSs may also be used by the UEs configured with eDRX.

UE power saving may be achieved by UE relaxing measurements for RLM/BFD. When configured, UE determines whether it is in low mobility state and/or whether its serving cell radio link quality is better than a threshold. The configuration for low mobility and good serving cell quality criterion is provided through dedicated RRC signaling.

RLM and BFD relaxation may be enabled/disabled separately through RRC Configuration. Additionally, RLM relaxation may be enabled/disabled on per Cell Group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE shall trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in TS 38.213, or monitors PDCCH according to the search space sets applied in SSSG.

To facilitate reducing gNB downlink transmission/uplink reception active time, UE can be configured with a periodic cell DTX/DRX pattern (i.e., active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells. When cell DTX is configured and activated for the concerned cell, the UE may not monitor PDCCH in selected cases or does not monitor SPS occasions during cell DTX non-active duration. When cell DRX is configured and activated for the concerned cell, the UE does not transmit on CG resources or does not transmit a SR during cell DRX non-active duration. This feature is only applicable to UEs in RRC_CONNECTED state and it does not impact Random Access procedure, SSB transmission, paging, and system information broadcasting. Cell DTX/DRX operation is only supported for single TRP scenario. Cell DTX/DRX can be activated/deactivated by RRC signaling or L1 group common signaling. Cell DTX/DRX is characterized by the following:
active duration: duration that the UE waits for to receive PDCCHs or SPS occasions, and transmit SR or CG. In this duration, the gNB transmission/reception of PDCCH, SPS, SR, CG, periodic and semi-persistent CSI report are not impacted for the purpose of network energy saving;
cycle: specifies the periodic repetition of the active-duration followed by a period of non-active duration.

Active duration and cycle parameters are common between cell DTX and cell DRX, when both are configured.

Once the gNB recognizes there is an emergency call or public safety related service, the network should ensure that there is no impact to that service (e.g., it may release or deactivate cell DTX/DRX configuration). The network should also ensure that there is at least partial overlapping between UE's connected mode DRX on-duration and cell DTX/DRX active duration, i.e., the UE's connected mode DRX periodicity is a multiple of cell DTX/DRX periodicity or vice versa.

A UE may support low-power synchronization signal (LP-SS) or low-power wake-up signal (LP-WUS), for example based on on-off keying (OOK) waveform, that are received by a low-power wake-up radio (LP-WUR) or a low-power radio (LR) for short. The following terminology may be used:
Main radio (MR): the Tx/Rx module operating for NR signals/channels apart from signals/channel related to low-power wake-up
LP-WUR (LR): The Rx module operating for receiving/processing signals/channel related to low-power wake-up.

Various methods can be used for UE power saving for paging monitoring. In order to reduce UE power consumption due to false paging alarms, the group of UEs monitoring the same PO can be further divided into multiple subgroups. With subgrouping, a UE shall monitor PDCCH in its PO for paging if the subgroup to which the UE belongs is paged as indicated via associated PEI and/or LP-WUS. If a UE cannot find its subgroup ID with the PEI and/or LP-WUS configurations in a cell or if the UE is unable to monitor the associated PEI and/or LP-WUS occasion corresponding to its PO, it shall monitor the paging in its PO. If the UE is configured with both LP-WUS and PEI, and it cannot find its subgroup ID with the LP-WUS or if the UE is unable to monitor the LP-WUS it monitors the following PEI or paging in its PO.

The gNB configures entry and exit conditions to monitor LP-WUS in system information. The UE may start monitoring LP-WUS when measurements using the MR are above the configured entry threshold(s), and the measurements using the LR are above the entry threshold(s), if configured. Exit conditions for LP-WUS monitoring are based on LR as specified in TS 38.304. LP-WUS monitoring can be disabled in the UE via NAS signaling. If this NAS signalling is absent LP-WUS monitoring is enabled.

On-demand SSB-based SCell operations are supported for UEs in RRC_CONNECTED configured with carrier aggregation (CA), applicable to both intra-band and inter-band CA configurations for FR1 and FR2 in non-shared spectrum. The OD-SSB transmission activation/deactivation command can only be transmitted to a UE configured with an SCell prior to or when receiving the SCell activation command. Both RRC and MAC-CE can be used for signalling the activation/deactivation state of OD-SSB transmissions. Additionally, the same MAC-CE can also update the transmission parameter of an activated OD-SSB after the SCell activation completion. The OD-SSB transmission deactivation can also be achieved implicitly based on the number of OD-SSB bursts to be transmitted configured by RRC. When there is no SSB on the SCell, the OD-SSB transmission is maintained while the SCell is activated. When SSB and OD-SSB have different centre frequencies in the SCell, only a single OD-SSB on a different center frequency is supported. L3 measurement on OD-SSB can be supported.

To facilitate reducing gNB downlink transmissions, instead of always periodically transmitting SIB1, the gNB can provide on-demand SIB1, i.e., upon receiving an OD-SIB1 request from a UE supporting OD-SIB1. OD-SIB1 is supported for UEs in RRC_IDLE, RRC_INACTIVE and RRC_CONNECTED when T311 is running. A request for SIB1 triggers a random access procedure, where MSG1 is used for indicating OD-SIB1 request and the gNB acknowledges the request in MSG2. OD-SIB1 request configurations of one or more cells which support OD-SIB1 are included in SIB26, which can be broadcasted in any cell, including cell's own OD-SIB1 request configuration. UE may request SIB1 based on the OD-SIB1 request configuration from SIB26 in order to determine the suitability of a cell during and after cell reselection. A gNB may request neighbour gNB(s) over the Xn interface to transmit or stop transmitting the OD-SIB1 configuration for a cell supporting OD-SIB1. The neighbour gNB(s) deciding to stop the OD-SIB1 configuration transmission informs the requesting gNB over Xn.

For adaptation of paging in time domain, the value range for parameter N, which is the number of paging frames in one paging cycle, is extended to make it possible to have increased interval between PFs. The value range for Ns, which is the number of paging occasions within one paging frame, is increased to compensate the decrease in the number of PFs. UEs supporting paging adaption and PEI can monitor PEI according to the additional PEI configuration, if configured.

Adaptation of SSB in time domain is supported for SCells for UEs in RRC_CONNECTED configured with carrier aggregation (CA). SSB adaptation is indicated via DCI. Multiple SMTC configurations can be configured to the UE, and the UE selects one SMTC based on the SSB adaptation indication.

Adaptation of PRACH configurations in time domain is supported for 4-step RACH CBRA. Furthermore, additional PRACH resource 1-bit indication in PDCCH-order applies to both CFRA and CBRA in the serving cell. Additional RACH resources are configured together with the common RACH resources in the same set of RACH resources, and the network can indicate via DCI whether the additional RACH resources are available.

In various embodiments or examples throughout the present disclosure, a 6G base station (6G gNB) or a 5G/4G gNB can be replaced with other corresponding network nodes, such as 6G integrated access and backhaul (IAB) or 6G network-controlled repeater (NCR) or 6G reconfigurable intelligent surface (RIS), or such as 5G NCR or IAB node, or a 4G relay or repeater node. In various embodiments, a 6G UE or a 5G/4G UE can operate in relation with multiple network nodes corresponding to a certain RAT (same RAT as that for the UE, or different RAT than that for the UE), such as both a 6G gNB and a 6G IAB/NCR/RIS, or both a 5G gNB and a 5G IAB/NCR, or both a 4G eNB and 4G relay/repeater node.

In various embodiments and examples throughout the present disclosure, a 6G/5G gNB or a 4G eNB can refer to a central unit (CU) or a distributed unit (DU) or a remote/radio unit (RU) or a transmission-reception point (TRP) or other architectural units or functional/logical entities for a corresponding base station, or a variation or collection or combination thereof.

Various embodiments, methods, and examples in the present disclosure are described in terms of downlink control channel, such as PDCCH/DCI. Similar methods can apply to various other downlink or uplink channels or signals, such as PUCCH/UCI, PRACH, SSB, CSI-RS, SRS, and so on. For example, for PUCCH transmission, one or more of 16-QAM or 64-QAM or other modulation types or modulation orders may be supported for PUCCH reception, in addition to or as an alternative for QPSK modulation. For example, for a UE in RRC_CONNECTED mode, the UE can be configured/indicated which modulation type/order to apply for a PUCCH resource or resource set, at least for dedicated PUCCH resources. For example, for a UE before RRC connection, or for a UE in IDLE/INACTIVE state operation, or for common PUCCH resources, the UE may only use QPSK for PUCCH transmission, or may be provided pre-configuration for an applicable modulation type/order, or the UE may receive a cell-specific or UE-group-specific L1/L2 signaling, such as a paging DCI format or a WUS PDCCH or a sequence-based WUS, to indicate an applicable modulation type/order.

The present disclosure is related to network energy saving (NES), including Cell DTX/DRX, as well as low-power operation such as downlink or uplink low-power wake-up signal (LP-WUS), or related to UE power saving.

In various embodiments, methods or examples, the UE can be configured a number of states, such as 2 or 4 operation states, for example UE/cell/carrier/TRP operation states, wherein configuration for each state provides information of which DL/UL signals or channels are enabled or disabled, and which DL/UL signals or channels are adapted, for example, transmitted or received with different/reduced number of antennas/power levels/beams/number of repetitions/reduced resources, and so on, and corresponding parameters for various DL/UL signals or channels, such as applicable periodicity, (maximum) modulation order, (maximum) rank, or other adaptations to various time/frequency/spatial/power/code/sequence domains, and so on.

For example, when only two states are configured/indicated, a first state may be referred to as an ‘active’ state, while a second state can be referred to as a ‘dormant state’ or a ‘deactivation state’.

For example, when more than two states, such as 3 or 4 or 6 or 8 states are configured/indicates, different states may be referred to by their state index, e.g., state index #N, and some or all states may have no labels or names (except possibly a smallest index state or a largest index state, which may be referred to with names such as one or more of ‘active’/‘dormant’/‘deactivated’ states, and so on). For example, a smaller state index can index higher level of activity and less adaptation (or vice versa). For example, such state can be different for uplink compared to downlink, such as deactivate/dormant state for uplink, while active state for downlink.

For example, higher layer signaling such as SIB or RRC or L1/L2 signaling such as a PDCCH/DCI/GC-DCI format or a DL WUS/LP-WUS/PDCCH-based WUS can indicate a state from the number of (2 to 8) configured states. For example, the UE starts to operate based on the cell/carrier/TRP state from an application time after reception of the L1/L2 signaling or corresponding HARQ-ACK feedback that the UE transmits on an UL channel in response to reception of such L1/L2 signaling.

For example, a UE or a NW may operate with same or different radio components in various states, such as operation with more/maximum radio components or RF chains or antennas elements/arrays/sub-arrays/panels in an active state or in a state with larger state index, while operating with less/minimum radio components or RF chains or antennas elements/arrays/sub-arrays/panels in a deactivated/dormant state or in a state with smaller state index. For example, such radio components/RF chains/antennas can correspond to a same transceiver, such as only main radio (MR), while certain components/RF chains/antennas can be switched ON/OFF or adapted, while in another example, different states may correspond to separate radios/transceivers, such as main radio (MR) and a low-power radio (LR), and so on. Such variations or adaptations of radio components within same or separate transceivers (MR or LR) can apply only for UE side or only for gNB/NW side or for both sides. For example, the gNB/NW side may (or may not) support separate LR and MR, or may support LR to be a reduced or adapted variation of MR, such as MR wherein certain radio components/RF chains/antennas are turned OFF or adapted.

For example, a UE may follow a broad framework for UE power saving or for NW energy saving, beyond only PDCCH monitoring, wherein various radio/PHY components can be set to power saving mode (e.g., low-power or turned off or adapted in time/frequency/spatial (T/F/S) domain or in power/code domain) in a time interval that can be referred to as a “dormant period” or in a UE/cell/carrier operation state the can be referred to as a “dormant” state or a generally a UE/cell/carrier state. Such dormant period or UE/cell/carrier state can be same as or an extension of a DRX Non-Active Time or of a time duration for PDCCH skipping, and corresponding start or stop or duration or parameters can be indicated or updated by L1/L2 signaling such as a DCI format or a WUS such as a DL WUS or LP-WUS. In addition, such dormant period or UE/cell/carrier state can be joint or separate from a “frequency-domain dormancy” or a “spatial-domain dormancy”, wherein certain or all DL/UL signals or channels are disabled for or adapted within a given frequency allocation, such as a BWP or a narrow-band (NB), or disabled for or adapted to a certain subset of beams or SSB indexes or TCI states or spatial relations. In a realization, a UE/cell/carrier state can include various such domains, including time/frequency/spatial/power/code/sequence domains, and can indicate enabling or disabling or adaptation of various DL/UL signals or channels or procedures. Such disabling or adaptation can apply to all or certain DL/UL reference signals or channels, with all or certain usage or configuration or associated with certain UE procedures. Such disabling or adaptation can be predetermined in the specifications of system operation or can be configured by higher layer signaling or can be indicated by L1/L2 signaling. Herein, adaptation of a DL/UL signal or channel or an UL signal or channel can refer to different parameters for reception or transmission of such DL/UL signal or channel, such as reception or transmission with reduced number of radio components/RF chains/receive antennas/transmit antennas or with reduced receive/transmit power levels, and so on. It can be specified or the UE can be configured by higher layers or indicated by L1/L2 signaling such as a DCI format or a sequence-based DL WUS or LP-WUS, to partially or fully override, suspend or cancel such disabling or adaptation, wherein (a) the UE can be triggered by the NW to receive or transmit some or all of such disabled or adapted DL/UL signals or channels periodically or for a number of occasions, and alternatively, or additionally, (b) the UE can initiate or request to receive or transmit some or all of such disabled or adapted DL/UL signals or channels periodically or for a number of occasions.

For example, such UE/cell/carrier/TRP state may operate independent of DRX operation, such as Cell DTX/DRX procedure or UE DRX/DTX procedure, or in relation with such DRX operation. For example, such UE/cell/carrier/TRP state can be an extension of the (UE/Cell) DRX/DTX operation, and when such a UE/cell/carrier/TRP state is configured or indicated, no separate UE/Cell DRX/DTX procedure applies. For example, various methods or examples throughout the present disclosure can apply with “outside DRX/DTX active time” or “during non-active time of DRX/DTX” with time durations associated with one or more UE/cell/carrier/TRP states. In another example, such UE/cell/carrier/TRP state may apply together with the (UE/Cell) DRX/DTX operation, for example, the UE operates based on (UE/Cell) DRX/DTX timers and counters, while the configured/indicated UE/cell/carrier/TRP states can provide information on applicable adaptation during DRX/DTX Active time period or duration, or during DRX/DTX non-Active time period or duration, or for both time periods/durations.

In one embodiment, during a UE/cell/carrier/TRP dormancy period or state such as outside Active time of Cell DTX (or Cell DTX/DRX), a UE can receive a PDCCH-based WUS or a sequence-based DL WUS or a DL LP-WUS that indicates whether and how the UE receives essential DL signals and channels. For example, outside Active time of Cell DTX, the UE may not receive SS/PBCH block, or may not monitor PDCCH/PDSCH associated with Type-0/0A/1/1A/2/2A CSS sets, and the UE may use variations of a synchronization signal or the DL WUS or DL LP-WUS to establish or maintain a (coarse) DL synchronization, or to perform procedures associated with mobility/RRM/RLF, or beam management/BFR. The UE can receive indications in the DL LP-WUS to receive a certain number of SSB bursts/indexes that provide improved synchronization or MIB updates or certain PDCCH monitoring occasions (MOs) to monitor and receive PDCCH for Type-0/0A/1/1A CSS sets that provides SIB updates or paging information. The UE can continue an ongoing Cell DTX cycle after reception of the indicated SSBs or Type-0/0A/1/1A PDCCHs. Alternatively, upon reception of DL WUS or LP-WUS, the UE can terminate the ongoing Cell DTX cycle such as the non-Active time and start a next Cell DTX cycle.

In various embodiments and examples, a DL LP-WUS refers to an LP-WUS as previously described or refers to any DL signal, such as any low-power DL signal, that serves as an (anchor) DL signal for wireless system operation, such as for cell-level operation.

For example, a signal generation for a DL LP-WUS can be as previously described or can be based on any other methods that achieves one or more of: low power consumption due to power-efficient modulation or resource allocation or power control/allocation (e.g., EPRE allocation) or other PHY generation aspects; low duty cycle, such as large periodicity, or aperiodic structure [without a discovery window or] within a discovery window of large size; adaptability, such as a possibility of disabling or enabling or PHY parameter update by higher layer signaling or by L1/L2 signaling. For example, one LP-WUS occasion can indicate the T/F resource (offset) for the next LP-WUS.

For example, outside Active time of Cell DTX, a UE may stop monitoring or reception of certain (essential) DL signals or channels for system/cell operation, such as one or more of: a DL signal for synchronization such as PSS/SSS, a DL channel for minimum system information such as PBCH, or a DL channel for providing (remaining) minimum system information or for paging or for certain steps of a random-access procedure, such as PDCCHs for one or more of Type-0/0A/1/1A/2/2A CCS sets or corresponding PDSCHs.

For example, outside Active time of Cell DTX, a UE can receive a DL LP-WUS to establish or maintain (coarse) DL synchronization, or to perform procedures associated with mobility/RRM/RLF, or beam management/BFR.

For example, a detection (with or without blind searching) of LP-SS or LP-WUS outside Active time of Cell DTX can be using a low-power radio (LR), such as a LP-WUR, that the UE operates, at least when a main radio (MR) is in a power-efficient mode of operation (such as turned OFF), or when a subset of MR's radio components, antennas or RF chains with same or reduced power levels, while other components, antennas or RF chains of the MR are turned OFF. For example, the LP-WUR can be a physical or logical or functional subset of the MR.

For example, outside Active time of Cell DTX, the UE can use a sync signal such as an LP-SS that is included in or is accompanied by a DL WUS or an LP-WUS to establish synchronization. For example, in time domain or frequency domain, the sync signal or the LP-SS is separate from, and attached to (e.g., in adjacent OFDM symbols or adjacent REs/RBs) the DL WUS or the LP-WUS. For example, DL WUS or LP-WUS is allocated in a time/frequency resources with an offset from the sync signal or LP-SS/LP-WUS, wherein the offset in time-domain or frequency-domain can be predetermined in the specifications of system operation or can be configured by higher layers, such as system information, or in an RRC configuration for Cell DTX procedure. For example, there may be no dedicated/separate DL signal such as a sync signal or LP-SS for synchronization that is separate from LP-WUS, and the UE can directly use the DL WUS or the LP-WUS for synchronization.

For example, the UE can be provided a time-frequency (T/F) configuration for LP-SS or LP-WUS. For example, during Cell DTX procedure, the UE maintain some T/F-synchronization based on SSB receptions before a start of Cell DTX procedure, and the UE refine such T/F-synchronization based on detection of LP-SS or LP-WUS in the corresponding configured T/F resources.

For example, outside Active time of Cell DTX, the UE can receive an LP-WUS or LP-SS with a same beam/spatial filter that was used for reception of a last SSB that the UE received during Active time of Cell DTX, or an SSB that the UE used in association with a last PRACH transmission during Active time of Cell DTX. In another example, higher layer configuration for Cell DTX can indicate an SSB index, and the UE can receive the LP-WUS with a same spatial filter that the UE used to receive the indicated SSB index during Active time of Cell DTX.

For example, the UE can be provided candidate T/F locations for LP-SS or LP-WUS for a cell, such as serving cell or a camped cell or a non-serving cell or a non-camped cell (such as a neighbor cell or a candidate cell for RRM/mobility/handover/LTM or for inter-cell beam management, and so on). For example, the UE may (blindly or quasi-blindly) search for and detect LP-SS or LP-WUS based on candidate frequency domain locations, such as sync-rasters for LP-SS/LP-WUS, within (an active BWP of) the corresponding cell. For example, the UE may be provided a discovery window in which the UE can detect at least one instance of the LP-SS or LP-WUS outside Active time of Cell DTX. For example, the UE may or may not lose T/F sync during Cell DTX due to SSB disabling, even though the UE was in RRC connected mode before Cell DTX.

For example, outside Active time of Cell DTX, the UE can receive an LP-WUS or LP-SS using any spatial filter (up to UE implementation), such as a spatial filter that results in a largest RSRP or an RSRP greater than a threshold.

In one approach, the specifications of system operation or higher layer signaling, such as an RRC configuration for Cell DTX, can indicate whether a UE can continue to receive SSB or PDCCH/PSDCH associated with one or more of Type-0/0A/1/1A/2/2A CCS sets, or whether such receptions are disabled, outside Active time of Cell DTX. In another example, such RRC configuration may not be provided, and the UE can determine such disabling based on configuration of LP-SS/LP-WUS for operation outside Active time of Cell DTX. For example, outside and within Active Time of Cell DTX/DRX, same or separate configurations may apply to reception of SSB or broadcast PDCCH, such as PDCCH or PDSCH associated with Type-0/0A/1/1A/2/2A CCS sets.

For example, system information may not be updated outside Active time of Cell DTX. For example, outside Active time of Cell DTX, a UE may/does not expect to (or is configured to not) receive PBCH or to monitor PDCCH (and receive PDSCH) associated with Type-0/0A CSS sets, such as for reception of DCI format 1_0 with CRC scrambled with SI-RNTI.

For example, DL traffic (at least low-priority DL traffic) may not trigger a UE paging outside Active time of Cell DTX. For example, the UE may/does not expect to (or is configured to not) monitor PDCCH (and receive PDSCH) associated with Type-1/1A CSS sets, such as for reception of DCI format 1_0 with CRC scrambled with P-RNTI or PEI-RNTI.

In another approach, in case of any system information update or DL traffic (such as high-priority DL traffic) for a UE, outside Active time of Cell DTX, the UE may receive an indication in the DL WUS or the LP-WUS, wherein the indication can trigger the UE to receive the system information update or to receive a paging for the DL traffic.

For example, an indication in the LP-WUS can trigger the UE to receive a number of one or more SSB occasions (SSB bursts or SSB indexes or on-demand SSB) for synchronization or for reception of updated minimum system information.

For example, the SSB occasion can be an immediately first/next SSB occasion (based on SSB pattern/configuration with Active time of Cell DTX) after a last symbol of the LP-WUS with such indication. For example, the indication in LP-WUS can include information of the SSB occasions, such as SSB indexes or slot/frame index for the SSB occasions, or a time-domain offset relative to the LP-WUS reception occasion.

For example, an indication in the LP-WUS can trigger the UE to monitor a certain PDCCH monitoring occasion (MO) for Type-0/0A CSS set for reception of a certain system information update, or for Type-1/1A CSS set, for example, for reception of paging information.

For example, the MO for such PDCCH monitoring for SI/paging can be an immediately first/next MO after a last symbol of the LP-WUS with such indication. In another example, the indication in LP-WUS can also indicate information of the PDCCH MO, such as an MO index, or a time-domain offset relative to the LP-WUS reception occasion.

For example, a DL WUS or a DL LP-WUS can provide same information as one or more of: PSS/SSS (for synchronization), or PBCH (for MIB update), or for one or more of Type-0/0A/1/1A/2/2A CCS sets (for broadcast PDCCH, such as for SI/paging update or RAR reception). For example, first one or more parameters of the DL WUS can indicate a purpose for the DL WUS (such as timing, or MIB update, or SIB update, or paging, or RAR, and so on), while second parameters of the DL WUS can indicate contents or information (fields) associated with such purpose.

For example, an indication in the LP-WUS can indicate a paging cause for a UE.

In a first option, outside Active time of Cell DTX, when the monitors PDCCH in a certain MO for Type-0/0A/2/2A CSS set based on an indication by LP-WUS, the UE continues to stay outside Active time of Cell DTX. For example, the UE does not monitor PDCCH in any other MOs for corresponding Type-0/0A/2/2A CSS sets.

In a second option, the UE considers an indication for monitoring PDCCH for Type-0/0A/1/1A CSS set as an indication to terminate the Cell DTX cycle, and to start a new Cell DTX cycle, or to start an ON timer for Cell DTX. In a variation, an indication in LP-WUS can also indicate whether the UE continues to stay outside Active time of an ongoing Cell DTX cycle, or whether the UE terminate an ongoing cycle of cell DTX and starts a new cell DTX cycle.

The second option can be beneficial, for example, to support a fast gNB-based termination of a Cell DTX cycle based on L1/L2 signaling, instead of waiting for completion of an RRC-configured duration of the Cell DTX cycle (that is, completion of the Active Time and non-Active Time).

For example, outside Active time of Cell DTX/DRX, the UE does not expect to monitor PDCCH for Type-1/1A CSS sets, except possibly a corresponding RA procedure is initiated by emergency serving as indicated by higher layers. Alternatively, or additionally, the UE may transmit a PRACH outside Active time of Cell DTX/DRX for other purposes, such as for UL WUS, or for indication of SR, such as for new data in UL buffer (possibly with high priority), and so on.

For example, outside Active time of cell DTX (or DRX), a UE can be a configured a set of RACH occasions (ROs) or a set of PRACH preambles that are a (strict/proper or improper) subset of ROs or PRACH preambles configured to the UE within Active time of Cell DTX (or DRX). For example, the UE does not expect to transmit a PRACH using a PRACH preamble, outside such subset of PRACH preamble, or in an RO, outside such subset of ROs. For example, such set of ROs or PRACH preambles are associated with an allowed RA trigger, such as emergency serving as indicated by higher layers.

For example, outside Active time of Cell DTX, when SSB is disabled and the UE receives DL LP-WUS, and when the UE is to transmit a PRACH (such as for an emergency service), the UE transmits a PRACH in association with DL LP-WUS instead of SSB. For example, the specifications of system operation or higher layer signaling provides information of an DL LP-WUS reception occasion to RO association. For example, the UE transmits the PRACH in an RO that is associated with a DL LP-WUS reception occasion index (and corresponding beam/spatial filter) that the UE received. For example, the UE may start to monitor a Type-1/1A in a window such as RAR/MsgB window after the PRACH transmission, or the UE may continue to not monitor Type-1/1A PDCCH and may receive RAR-MsgB-like information via another DL WUS. For example, a DL WUS or an LP-WUS may provide a header to indicate that the following information related to a random access response, and the other information can include one or more of: RACH preamble ID (RAPID), an UL timing advance (TA), an RNTI such as a TC-RNTI or a C-RNTI or a WUS-RNTI. The information may also include a Msg3 UL grant.

For example, a DL LP-WUS, such as a two-stage LP-WUS, can provide small data transmission (SDT), such as information contents of a broadcast PDCCH such as a fallback DCI (0_1/1_1) or variations thereof, such as for SIB or SIB update or paging or RAR or other common control information, or a small DL-SCH or UL-SCH data of same or similar size, such as 56 bits with or without CRC, or can provide paging information or small system information update, or ETWS, and so on. For example, the LP-WUS can schedule reception of a small PDSCH for the MR or a low-power variant of PDSCH (for example, based on OFDM waveform or OOK modulation/waveform) by an LR of the UE.

For example, such information can be provided only by a second stage/part of the LP-WUS, or by a combination of payload of the first stage/part and second stage/part of the LP-WUS. In another example, such information can be provided by a single-stage DL WUS, such as a sequence-based DL WUS with OFDM waveform, that include sufficient number of symbols/slots/REs/RBs to accommodate such payload. For example, certain payload can be multiplexed in power domain such as EPRE or in code domain, such as cyclic shift or phase rotation or orthogonal cover codes (OCC) or small shift/large shift, and so on.

For example, a first stage of the DL LP-WUS can apply to a group of UEs, while indicating a presence of a second stage of DL WUS/LP-WUS for first one or more UEs from the group of UEs or for first one or more groups of UEs among a number of groups of UEs. For example, the UE receives and applies the information in the second stage of LP-WUS only for the first one or more UEs or only for the first one or more groups of UEs.

Similar can apply to an UL WUS, such as an LP UL-WUS, wherein the UE can transmit small data transmission to the gNB.

In one embodiment, outside Active time of Cell DRX, a UE can transmit an UL WUS (e.g., UL LP-WUS) to request for immediate termination of an ongoing Cell DRX cycle or for fast deactivation of the Cell DRX configuration for one or more cells. The UE applies such termination/deactivation of Cell DRX after receiving a positive confirmation/indication from the gNB, for example, in a DL LP-WUS or as a system information update. The UL WUS can be a low-power/power-efficient signal or channel for one or both of the gNB and the UE.

For example, outside Active time of Cell DRX, when UE has UL traffic (such as high-priority traffic), the UE can transmit an UL WUS, such as an UL LP-WUS, to terminate (or to request for termination of) an ongoing Cell DRX cycle.

Such method can be beneficial, for example, to support a fast UE-initiated termination of a Cell DRX cycle based on L1/L2 signaling, instead of waiting for completion of an RRC-configured duration of the Cell DRX cycle.

For example, the UL WUS can be a PRACH, or a PUCCH, or an SRS, or a CG PUSCH.

For example, the UL WUS can be a low-power UL signal (e.g., UL LP-WUS), that serves as a trigger for cell-level wake-up. For example, the UL LP-WUS can be a low-power variation of PRACH or PUCCH or SRS or CG PUSCH. Alternatively, the UL LP-WUS can a separate UL signal that is different from PRACH, PUCCH, SRS and CG PUSCH, or low-power variations thereof.

For example, a signal generation for an UL LP-WUS can be similar to DL LP-WUS as previously described or can be based on any other methods that achieves one or more of: low power consumption due to power-efficient modulation (e.g., OOK or FSK) or resource allocation or power control/allocation (e.g., P0 allocation) or other PHY generation aspects; low duty cycle, such as large periodicity, or an aperiodic structure [without a discovery window or] a within a discovery window of large size; adaptability, such as a possibility of disabling or enabling or PHY parameter update by higher layer signaling or by L1/L2 signaling.

In a first method, when the UE transmits an UL WUS (e.g., UL LP-WUS) outside Active time of Cell DRX, the UE considers an ongoing cycle of Cell DRX to be immediately terminated, and the UE starts a next cycle of Cell DRX, possibly including a slot/symbol offset before starting Active time of such next cycle of Cell DRX. In a variation, the UE considers that the Cell DRX procedures is deactivated for a corresponding cell, and that the limitations of Cell DRX for UE transmissions and procedures (e.g., no transmission of CG PUSCH, PUCCH, PRACH, and so on) do not apply anymore. For example, the indication can be for one or more cells.

For example, the UE may or may not expect to receive a confirmation from the gNB in response to the UL WUS (e.g., UL LP-WUS) transmission, wherein a confirmation can be provided by a DL LP-WUS, if present, or by an update of system information, such a DCI format 1_0 monitored in a Type-0/0A CSS set. For example, such confirmation, when received, can indicate only an affirmation response from the gNB (and not declining the UE assumption).

In a second method, a transmission of an UL WUS (e.g., UL LP-WUS) by a UE outside Active time of Cell DRX is considered as a UE request from the gNB to terminate an ongoing cycle of Cell DRX or to deactivate a Cell DRX configuration. For example, the request can be for one or more cells. For example, it is up to the gNB to accept or decline such UE request.

For example, the UE is expected to continue the procedures of Cell DRX until the UE receives an indication from the gNB for such termination/deactivation. For example, such gNB indication can be provided by a DL LP-WUS, if present, or by an update of system information, such a DCI format 1_0 monitored in a Type-0/0A CSS set. For example, such gNB indication, when received, can indicate either accepting the UE request or can decline the UE request.

For example, outside Active time of Cell DRX, the UE can receive an indication in the DL LP-WUS or in the SI update that indicates to the UE that:
an ongoing Cell DRX cycle is terminated immediately, and the UE is to start, possibly after a certain symbol/slot offset, an Active time of a next Cell DRX cycle, or
a Cell DRX configuration for a corresponding cell is deactivated.

For example, when the UE receives DL LP-WUS or SI update on only one cell, such as PCell or SpCell, the UE can receive an indication of a cell for which such Cell DRX termination/deactivation is applied. For example, the indication can include a cell index or an index of a cell combination or a cell group, or the indication can be in terms of a bitmap corresponding to a predetermined/configured number of cells for the UE (and in ascending order of cell index), wherein a bit in the bitmap indicates whether Cell DRX termination/deactivation is applied (e.g., value ‘1’) or is not applies (e.g., value ‘0’) for a corresponding cell.

For example, the UE applies a termination/deactivation of Cell DRX a certain number of symbols/slots after:
transmission of the UL WUS (e.g., UL LP-WUS), at least in the first method and when the UE does expect a confirmation from the gNB, or
reception of the gNB confirmation or positive indication (e.g., by DL LP-WUS or by SI update), at least in the second method and possibly also in the first method when the UE expects a confirmation from the gNB.

For example, the certain number of symbols or slots are predetermined in the specifications of system operation or are configured by higher layers.

For example, the UE can be provided information of time/frequency resources for transmission of UL WUS (e.g., UL LP-WUS). For example, T/F resources for UL WUS (e.g., UL LP-WUS) can be in terms of absolute slot and symbol indexes or patterns thereof, such as a periodicity and offset, and RB/RE indexes, or frequency-domain start and length resource indication value (RIV), or can be in terms of relative T/F configuration, such as a T/F offset relative to SSB such as periodic SSB or aperiodic or on-demand SSB or relative to DL LP-WUS.

In one example, time occasion in which a UE can terminate the Cell DRX can be based on time occasions for transmission of UL WUS, such as UL LP-WUS. In one option, an LP receiver of the gNB can be always open for energy detection, and the UE can transmit a sequence-based UL WUS at any time. In another option, the UE can transmit an UL WUS, such as an UL LP-WUS only in certain occasion, with a periodicity, or based on a duty cycle.

For example, higher layer signaling such as system information or RRC signaling can provide the information of T/F resources for UL WUS (e.g., UL LP-WUS). For example, the information can be provided by an RRC configuration for Cell DRX or can be a separate RRC configuration for UL WUS/UL LP-WUS that may also be used in other scenarios, or can be indicated by a DCI format 2_9 that activates the Cell DRX for a cell.

For example, the UE transmits the UL WUS (e.g., UL LP-WUS) with a same beam that the UE used to receive a last SSB during Active time of an ongoing Cell DRX cycle. For example, the UE transmits the UL WUS (e.g., UL LP-WUS) with a same beam that the UE used for reception of an SSB that was associated with a last PRACH transmission during Active time of an ongoing Cell DRX cycle. For example, a beam or SSB for UL WUS (e.g., UL LP-WUS) can be configured by higher layers, such as an RRC configuration for Cell DRX, or can be indicated by a DCI format 2_9 that indicates to the UE to switch a Cell DRX state.

For example, the UE can be provided information of a set of occasions for UL WUS (e.g., UL LP-WUS) transmission, and the UE can be provided a predetermined or higher-layer configured association among SSBs or DL LP-WUS indexes (with different spatial beams) and the set of occasions for UL WUS. For example, the UE selects an SSB or DL LP-WUS up to UE implementation or based on certain predetermined rules (e.g., highest RSRP or RSRP above certain threshold), and the UE transmits the UL WUS (e.g., UL LP-WUS) in an occasion that is associated with the selected SSB or DL LP-WUS.

For example, when the UE is configured to transmit UL WUS (e.g., UL LP-WUS), the UE may assume that the gNB suspends transmission of SSB in the corresponding cell outside Active time of Cell DRX. For example, the UE can receive DL LP-WUS instead of SSB, as previously described herein. For example, when Cell DRX is terminated, the UE may assume that the gNB resumes transmission of SSB in the corresponding cell.

In another example, when the UE is configured to transmit UL WUS (e.g., UL LP-WUS), the UE may assume that the gNB suspend transmission of any DL RS for synchronization, such as both SSB and DL LP-WUS, outside Active time of Cell DRX. For example, the UE may assume that a receiver, such as a low-power receiver (LR) of the gNB, may be continuously ‘open’ and operational, such as for energy detection, and that the gNB may re-activate/resume transmission of SSB or DL LP-WUS upon reception of the UL WUS (e.g., UL LP-WUS).

Various methods may consider low-power receiver (LP-WUR) or low-power transmit radio at the gNB side, in addition to or instead of the UE side. Similar methods for UE-initiated or UE-based starting or stopping of PDCCH monitoring or other UE procedures, such as by using UL WUS or UL LP-WUS, for example, in case of UE C-DRX or to PDCCH skipping instead of or in addition to Cell DTX/DRX.

For example, such UE-based or UE-initiated starting or stopping of PDCCH monitoring or certain other UE procedures can be based on UE assistance information, such as one or more of: UE battery information, UE UL traffic information, for example, arrival or size or timing of the UL traffic, MPE or other preferred power-domain or beam-domain information, or can be based on a UE type, such as a UE with reduced capabilities, or an IoT UE, and so on.

In a first realization, L1/L2 signaling such as DL WUS/LP-WUS or DCI/GC-DCI/cell-specific DCI can terminate a non-active time period or duration of Cell DTX/DRX, with or without triggering reference signals, such as on-demand SSB or aperiodic TRS or CSI-RS or SRS, (immediately) before or (immediately) after such termination.

In a second realization, L1/L2 signaling such as DL WUS/LP-WUS or DCI/GC-DCI/cell-specific DCI may only trigger reference signals, such as on-demand SSB or aperiodic TRS or CSI-RS or SRS, during a DRX/DTX non-active time period or duration without terminating such period or duration; for example, the UE continues the non-active time period or duration as predetermined/configured/indicated (e.g., disabled/reduced/adapted PDCCH monitoring or disabled/reduced/adapted reception or transmission of DL/UL signals or channels, or disabled/reduced/adapted UE procedures such as various measurements or reporting, and so on).

In a variation, NW signaling such as higher layer signaling or L1/L2 signaling can indicate whether the first realization or the second realization applies, such as whether to terminate the DTX/DRX non-active time period or duration, or continue such non-active time period or duration without termination. For example, a same L1/L2 signaling such as GC-DCI or DL WUS that triggers the on-demand or aperiodic RS such as SSB/TRS/CSI-RS/SRS can indicate whether a DTX/DRX non-active time period or duration is continued or terminated, or if/when terminated, can indicate whether a reception or transmission of such on-demand or aperiodic RS is (immediately) before or (immediately) after such termination, or can indicate a time offset from indication or application of such termination.

For example, a number of instances/occasions for such on-demand or aperiodic RS such as SSB/TRS/CSI-RS/SRS can be configured by higher layers such as SIB or RRC or can be indicated by the GC-DCI or DL WUS that triggers such RS.

In another example, spatial directions or beams for such on-demand or aperiodic RS can be configured by higher layers or can be indicated by L1/L2 signaling such as a GC-DCI or DL WUS, for example, one that triggers such RS. For example, the UE can receive SIB or RRC signaling that configured a number of OD-SSB receptions based on GC-DCI or DL WUS trigger during non-Active time of Cell DTX/DRX, while the GC-DCI or the DL WUS can indicate SSB beam indexes such as ssb-PositionsInBurst or corresponding spatial relations/filters or TCI states. For example, the gNB can trigger OD-SSB reception only in certain directions that have more cell loading, such as (more) UEs transmitting PRACH or UL WUS. For example, such beam indexes can be same as or different from (e.g., a subset of or partial or full non-overlap with) first SSB indexes or TCI states, if any, that are transmitted during non-active time of Cell DTX/DRX or second SSB indexes or TCI states that are transmitted during active time of Cell DTX/DRX.

In various methods or examples, a cell-specific DCI refers to a DCI for example with cell-specific RNTI provided by a broadcast PDCCH in a cell-specific or common CORESET and according to a cell-specific or common search space set.

In one example, a DL WUS can provide a small payload of control information such as some or all information contents provided by a broadcast PDCCH/fallback DCI, such as one for scheduling system information, or paging or RAR and so on. In another example, a DL WUS can provide a small payload of data information, such as some or all information content of a PDSCH that provides SIB or SIB update or paging or RAR and so on. For example, the DL WUS can provide an indication whether the content is for control/scheduling information or for the data/message information.

In one approach, a random access procedure during non-active time of Cell DTX/DRX is supported, at least for certain random access triggers. When a UE transmits a PRACH during a non-active time of Cell DTX/DRX, in one example, the UE does not receive a PDCCH/PDSCH for RAR, and the UE receives associated RAR information in a DL WUS/LP-WUS that the UE receives a monitoring window after the PRACH transmission, while still in the non-active time of Cell DTX/DRX. In another variation, the UE does not receive a DL WUS/LP-WUS in response to the PRACH transmission, and directly receives a RAR PDCCH/PDSCH in response to the PRACH transmission.

In another example, the UE receives a DL WUS/LP-WUS that triggers/indicates reception of a RAR PDCCH/PDSCH. For example, the UE receives a DL WUS/LP-WUS in a time window after the PRACH transmission, and the DL WUS/LP-WUS indicates/triggers RAR PDCCH reception, and accordingly the UE attempts to receive a RAR PDCCH/PDSCH. For example, when such DL WUS/LP-WUS is not received in a time window after the PRACH transmission, or when the UE receives a DL WUS/LP-WUS in a time window after the PRACH transmission, and the DL WUS/LP-WUS indicates/triggers no PDCCH reception, the UE does not attempt to receive a RAR PDCCH/PDSCH.

In another example, the UE may receive a DL WUS in a time window after the PRACH transmission that terminates the Cell DTX/DRX non-active time, and the UE can receive a RAR PDCCH/PDSCH during active time of Cell DTX/DRX. In another example, such DL WUS may not be needed, and the UE determines termination of Cell DTX/DRX non-active time upon transmission of the PRACH, and the UE directly starts the active time and attempts to receive RAR PDCCH/PDSCH.

In one example, the UE can transmit a PRACH transmission (or PUCCH transmission or other UL transmission) only as a wake-up request, such as an UL wake-up signal (UL WUS). For example, no response to UL WUS via RAR PDCCH/PDSCH or via DL WUS/LP-WUS may apply. For example, the UE/cell/carrier/TRP wake-up can be after a synchronization or time/frequency tracking (e.g., AGC setup or calibration) for a number of instances or occasions after the PRACH transmission that can be prior to or after a termination of the Cell DTX/DRX non-active time. Such operation may apply in general for various cells/carriers/TRPs, or may be restricted to certain scenarios, such as a single cell operation, and may not apply to multi-cell/carrier-aggregation operation.

For example, specifications of system operation can predetermine or higher layer signaling can configure or L1/L2 signaling (such as one for trigger/start/stop of Cell DRX/DTX) can indicate which one or more of the aforementioned methods apply for PRACH/UL WUS transmission during non-Active time of Cell DTX/DRX.

For example, such PRACH or UL WUS can be associated with periodic RS/sync signal such as SSB or TRS/CSI-RS, if any, during non-active time of Cell DTX/DRX, or associated with the DL WUS/LP-WUS or an accompanied or attached PSS/SSS/LP-SS, or associated with on-demand or aperiodic RS/sync signal that is triggered by the GC-DCI or L-WUS during non-active time of Cell DTX/DRX. For example, such association can be based on indexes of the RS/sync signal with indexes of ROs or UL WUS occasions or PRACH preambles formats, for example, similar to SSB-to-RO association in 5G NR as described in TS 38.213.

For example, when sync signal such as SSB or periodic TRS/CSI-RS is disabled or adapted on a cell/carrier/TRP, for example during non-active time of Cell DTX/DRX, the UE performs measurements such as RRM/mobility/LTM measurements or CSI/BM/BFR/RLM/RLF measurements based on sync signal on an associated cell, such as a PCell, or another SCell, or a non-serving cell, such an associated neighbor cell, or a non-camped cell, or another coverage cell/PCell, and so on. In another example, the UE can be triggered to perform on-demand measurements such as on-demand RRM/mobility measurements based on on-demand RS/sync signal, for example, OD-SSB or OD-RS or aperiodic TRS/CSI-RS and so on. For example, the UE can receive L1/L2 signaling such as GC-DCI or DL WUS/LP-WUS that triggers OD-SSB or aperiodic TRS/CSI-RS and so on, and such trigger also triggers on-demand measurement, or another indication via higher layer signaling or within the GC-DCI or DL WUS can indicate whether on-demand measurement based on such triggered on-demand or aperiodic RS applies.

In another example, the UE can perform measurements such as one or more of the aforementioned measurements based on a DL WUS/LP-WUS, or a sync signal associated with or included in or accompanied with the DL WUS/LP-WUS. For example, the DL WUS/LP-WUS can provide some synchronization. For example, DL WUS/LP-WUS can be based on PSS or SSS or LP-SS or variations thereof. For example, DL WUS/LP-WUS can be attached to a sync signal such as PSS or SSS or LP-SS or can have such sync signal within a time/frequency offset.

In another variation, the UE does not expect that reference signal such as period RS for measurement, such as for RRM/mobility/LTM measurement can be fully disabled on a cell/carrier/TRP during non-active time of Cell DTX/DRX. For example, the UE expects to (be configured to) receive DL RS for such measurement, wherein a periodicity of such DL RS can be no smaller than (or no larger than) or a fraction or a factor of a periodicity of the Cell DTX/DRX cycle, or of the Cell DTX/DRX non-active time, or of the Cell DTX/DRX active time.

In another example, the specifications of system operation can predetermine or higher layer signaling such as SIB or RRC can configure one or both of:
a UE that transmits PRACH enters active DTX/DRX period by monitoring PDCCH (e.g. because it will transmit SR to get scheduled, or
a UE that does not transmit PRACH enters active DTX/DRX by monitoring WUS and activates PDCCH monitoring if so indicated by WUS (e.g., by the base station in case of DL data). Such may apply, additionally or alternatively, in non-active period if the DL WUS can be UE-specific—then, the UE that receives such DL WUS enters active period by monitoring PDCCH, and a UE that does not receive such DL WUS continues to monitors WUS.

Combinations or variations may also apply based on dependence or interaction of cell DTX/DRX and WUS (PDCCH-based WUS or sequence-based DL WUS) monitoring for triggering PDCCH monitoring, when UE has been such configured.

For example, the UE can be configured time/frequency resources, such as candidate resources or candidate occasions, to receive DL WUS/LP-WUS or PDCCH-based WUS such as GC-DCI. For example, the UE can be configured WUS search space sets to inform the UE of candidate time resources for the DL WUS, while frequency resources or combination of time and frequency resources can be referred to as WUS monitoring occasions or candidates that the UE can identify or determine. Such can be defined, for example, similar to search space and MOs for PDCCH monitoring/reception, for example, as described in TS 38.213, possibly (with or) without any blind decoding.

In one embodiment, the specification of system operations, higher layer signaling, or a DCI format (e.g., 2_9) for Cell DTX/DRX configuration/activation can indicate that various DL/UL signals or channels are disabled outside Active time of Cell DTX/DRX, such as CSI-RS or SRS or unicast PDCCH or PUCCH. The UE does not perform UE procedures associated with such disabled DL/UL signals or channels, or the UE performs corresponding UE procedures using alternative DL/UL signals or channels, such as SSB or DL LP-WUS (that are QCL with a disabled CSI-RS or SRS) or PRACH.

For example, outside Active time of Cell DTX, various DL signals or channels can be disabled, such as:
CSI-RS or DL positioning reference signal (DL PRS),
a PDCCH for scheduling DL/UL retransmission (including for DL/UL retransmission of PDSCH/PUSCH that was initially received/transmitted within Active time of Cell DRX), or
a PDCCH in response to PUCCH with SR can be disabled.

For example, outside Active time of Cell DRX, various UL signals or channels can be disabled, such as:
SRS or SRS for positing, or
aperiodic CSI reporting on PUSCH (e.g., a PUSCH that is scheduled within Active time of Cell DRX, while the PUSCH transmission is outside Active time of Cell DRX), or
a PUCCH for link recovery request (LRR, also known as, beam failure recovery/BFR).

In one example, the specification of system operations disables some or all of the previously described DL/UL signals or channels are disabled or enabled outside Active time of Cell DTX/DRX. For example, the UE does not expect to receive such DL signals or channels outside Active time of Cell DTX on a corresponding cell, or the UE does not expect to transmit such UL signals or channels outside Active time of Cell DRX on a corresponding cell.

For example, higher layer configuration, such as configuration of Cell DTX/DRX, or a DCI format 2_9 for indication/activation of Cell DTX/DRX can indicate whether some or all of the previously described DL/UL signals or channels are disabled or enabled outside Active time of Cell DTX/DRX on a corresponding cell. For example, such RRC-based or L1/L2-based disabling can be common for such DL/UL signals or channels, or can be separate for different DL/UL signals or channels, including joint or separate indication for Cell DTX and Cell DRX procedures.

For example, when a certain DL/UL signal or channel is disabled, in one option, the UE does not expect to perform a corresponding UE procedure. For example, the UE does not report CSI when CSI-RS reception is disabled or does not perform DL-side positioning methods when DL PRS is disabled, or the UE does not transmit SRS (at least SRS associated with PUSCH, such as SRS for ‘codebook-based’ and ‘non-codebook-based’ PUSCH transmission) when SRS is disabled. For example, a transport block is considered as ‘failed’ when corresponding original PDSCH/PUSCH or respective HARQ retransmissions thereof are not successfully decoded within Active time of Cell DTX/DRX.

In another option, the UE performs a corresponding UE procedure based on an alternative DL/UL signal or channel. For example, the UE performs “CSI” reporting based on SSBs (such as SSB indexes associated with corresponding disabled CSI-RS), or the UE transmits a PRACH in case of RLF or LLR/BFR. For example, the UE performs beam management or beam failure recovery procedures associated with disabled CSI-RS or SRS based on SSB or DL LP-WUS that are associated with the disabled CSI-RS or SRS.

In one example, the UE can be configured a number of “dormancy states” for Cell DTX/DRX, wherein there is an association among the dormancy states and the set of signals or channels that can be disabled or skipped during the Cell DTX/DRX. For example, the UE skips transmitting or receiving first UL/DL signals or channels outside active time of Cell DTX/DRX when a corresponding dormancy state is a first dormancy state, and the UE skips transmitting or receiving second UL/DL signals or channels outside active time of Cell DTX/DRX when a corresponding dormancy state is a second dormancy state. For example, the UE does not skip CG PUSCH and SPS PDSCH in the first dormancy state, while the UE skips CG PUSCH and SPS PDSCH in the second dormancy state. For example, the association is predetermined in the specifications of system operation or can be configured by higher layers. For example, an applicable dormancy state can be provided in higher layer configuration for the Cell DTX/DRX, or can be indicated by L1/L2 signaling, such as by a DCI format 2_9 for indication of Cell DTX/DRX. For example, the UE can operate with more than one Cell DTX/DRX configurations, each with separate DRX parameters and with a separate dormancy state. For example, a DCI format 2_9 for Cell DTX/DRX indication can also indicate a dormancy state applicable to the Cell DTX/DRX.

For example, certain disabling of the UE procedures or transmissions or receptions of certain signals or channels during Cell DTX/DRX can be UE-group-specific or UE-type-specific, such as different configuration or information for UEs with baseline capabilities, or UEs with reduced capabilities, or IoT UEs, and so on.

In one embodiment, for fast adaptation of Cell DTX/DRX, a UE can receive a field/information in a DCI format (e.g., 2_9) for activation of Cell DTX/DRX or in a DL LP-WUS that indicates to a UE value, from multiple configured values, for one or more of the Cell DTX/DRX parameters, such as ON duration or cycle length, or indicates to the UE an index of a configuration or sub-configuration, from multiple configurations or sub-configurations, for Cell DTX/DRX. The indication in the DCI format (e.g., 2_9) can be applicable within Active time of Cell DTX/DRX, and the indication by the DL LP-WUS can be applicable outside Active time of Cell DTX/DRX.

For example, the UE can receive higher layer signaling that configures more than one values for certain parameters of Cell DTX/DRX, such as one or more of: an ON/Active time duration as provided by cellDTX-DRX-onDurationTimer, or a Cycle duration as provided by cellDTX-DRX-Cycle, a symbol/slot offset applicable to the ON timer, and so on. For example, an L1/L2 signaling can indicate a value from the respective more than one value.

For example, the UE can receive higher layer signaling that provides more than one configurations (or more than one sub-configurations) for Cell DTX/DRX, wherein each configuration or sub-configuration provides a set of values for various parameters of Cell DTX/DRX. For example, the UE can receive L1/L2 signaling that indicates a configuration/sub-configuration from the more than one configurations/sub-configurations.

For example, configured or indicated values can correspond to one or both of Cell DTX and Cell DRX procedures.

Various methods can be considered for L1/L2 indication of parameters for Cell DTX/DRX.

In one method, a DCI format (e.g., 2_9) for activation of Cell DTX/DRX can also indicate values for the corresponding parameters or index of an applicable configuration/sub-configuration. For example, a DCI format 2_9 can separately or jointly indicate an activation of Cell DTX/DRX and an applicable duration of the ON timer.

Such method can be beneficial, at least, for adaptation of the Cell DTX/DRX procedure within Active time of Cell DTX/DRX, as the UE may receive such DCI format 2_9 only within Active time of Cell DRX/DTX.

In another method, a DL LP-WUS can indicate values for the corresponding parameters or index of an applicable configuration/sub-configuration. For example, such indication can be jointly encoded (in a number of codepoints) with an indication for termination or deactivation of Cell DTX/DRX, as previously described herein. For example, first/second/third codepoints of a 2-bit field in DL LP-WUS indicate first/second/third values for the respective parameters of Cell DTX/DRX, while a fourth codepoint of the field in DL LP-WUS indicates that the Cell DTX/DRX is terminated or deactivated.

Such method can be beneficial, at least, for adaptation of Cell DTX/DRX outside a corresponding Active time of the Cell DTX/DRX.

In one embodiment, a UE can be configured a number of one or more cell groups for Cell DTX/DRX operation, wherein same parameters, such as same ON timer and same cycle length, or same indications, such as for Cell DTX/DRX activation or deactivation, apply to different cells in the cell group. Alternatively, each cell in the cell group can operate with separate parameters, while the UE determines an Active time for Cell DTX/DRX jointly across different cells of the cell group.

In one method, the UE can be configured one Cell DTX/DRX configuration for a group of cells, such as serving cells (or non-serving cells). For example, the configuration can include cell indexes to which the Cell DTX/DRX configuration applies. The UE can be configured one or more cell groups for Cell DTX/DRX operation. For example, such methods can apply to non-serving cells in case of seamless mobility, UE-centric mobility, cell-free mobility, LTM, conditional handover, inter-cell multi-TRP, and so on.

For example, a single ON timer and a single value of cycle length/duration applies to Cell DTX/DRX for different cells in the group of cells. For example, a same activation or deactivation status by RRC signaling or by L1/L2 signaling, such as a DCI format 2_9, applies to different cells in the group of cells. For example, the UE does not expect to be configured or indicated different values of ON timer, or cycle length, or DTX/DRX activation or deactivation status to different cells in the group of cells.

For example, when an ON timer for Cell DTX/DRX associated with a group of cells expires, the UE may assume that all serving cells in the group of cells are outside Active time of Cell DTX/DRX, and the UE may apply all corresponding procedures for Cell DTX/DRX, such as disabling DL/UL transmissions or disabling certain PDCCH monitoring, and so on, as previously described.

In another method, different Cell DTX/DRX configurations may apply to different cells in a cell group, while a definition of Active time for Cell DTX/DRX is across cells in the cell group. For example, when cell DTX/DRX is configured and activated for a Serving Cell, the cell DTX/DRX Active Period includes the time while: cellDTX-DRX-onDurationTimer is running for the associated cell or for any cell in a same cell group for cell DTX/DRX operation (e.g., RRC parameter cellGroupForCellDTX-DRX) as the associated cell. For example, when a ON timer is running for one cell in the corresponding cell group, the UE assumes all serving cells in the corresponding cell group to be within Active time for Cell DTX/DRX. Although, such operation extends the Active time, it can ensure a consistent behavior across different cells in the cell group.

Such methods can be beneficial, for example, for intra-band, co-located cells, or to cells that partially or fully share a same RF chain. Such method can be beneficial that the gNB can apply a power-efficient mode of operation (e.g., disabling or turning off the RF chain) associated with the cells, without any inconsistency or conflicting operations.

Such methods can be also beneficial, for example, to save signaling overhead, as same RRC configuration or same indication by L1/L2 signaling (e.g., DCI format 2_9) can apply to a group of cells.

For example, cells in a master cell group (MCG) can be a first/primary cell group for Cell DTX/DRX, and cells in a secondary cell group (SCG), if configured, can be a second/secondary cell group for Cell DTX/DTX. In another example, a cell group for Cell DTX/DRX are same as a PUCCH group, such primary PUCCH group, and secondary PUCCH group.

In another example, cells in a cell group for Cell DTX/DRX operation include cells in a same frequency band, or cells in adjacent frequency bands, or cells in a same frequency range, such a first cell group for FR1 cell, a second cell group for FR2-1 cells, a third cell group for FR3 cells, and a fourth cell group for FR2-2 cells. For example, the fourth cell group may be combined with the second cell group.

For example, same or separate cell groups can be configured for Cell DTX operation and for Cell DRX operation.

In one embodiment, a UE can be configured LP-WUS on a first cell, such as an FR1 PCell, that indicates wake-up/no-wake-up for PDCCH monitoring or disabling or enabling other UE procedures such as CSI/RRM measurements on a second cell or a group of second cells, such as FR2 or FR3 SCells. Similar, an LP-SS on the first cell can be used for UE procedures that are based on SSB on the second cell or the group of second cells, thereby facilitating a disabling of SSB on the second cell.

For example, the LP-WUS can include an explicit field or provide a separate indication based on a sequence parameter value to indicate whether the information in the LP-WUS is for the first cell or for the second cell(s). For example, the UE can be configured different reception occasions for LP-WUS on the first cell, such as first occasions associated with indications for the first cell, and second occasions associated with indications for the second cell.

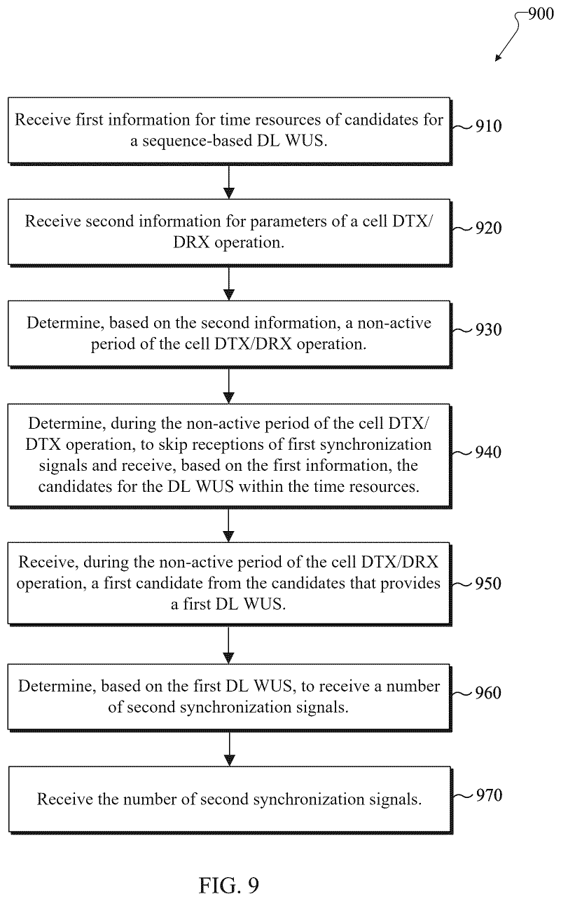

FIG. 9 illustrates an example method 900 performed by a UE in a wireless communication system according to embodiments of the present disclosure. The method 900 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

The method 900 begins with the UE receiving first information for time resources of candidates for a sequence-based DL WUS (910). The UE then receives second information for parameters of a cell DTX/DRX operation (920). The UE then determines, based on the second information, a non-active period of the cell DTX/DRX operation (930).

The UE then determines, during the non-active period of the cell DTX/DTX operation, to skip receptions of first synchronization signals and receive, based on the first information, the candidates for the DL WUS within the time resources (940). The UE then receives, during the non-active period of the cell DTX/DRX operation, a first candidate from the candidates that provides a first DL WUS (950). The UE then determines, based on the first DL WUS, to receive a number of second synchronization signals (960). The UE then receives the number of second synchronization signals (970).

In various embodiments, the UE may also receive the number of second synchronization signals within the non-active period of the cell DTX/DRX operation.

In various embodiments, the UE may also receive a SIB or cell-specific RRC signaling that indicates one or more of time, frequency, spatial, power, or sequence parameters for receiving the number of second synchronization signals.

In various embodiments, the UE may also receive a SIB that indicates ROs, determine an RO, from the ROs, that is associated with a synchronization signal from the number of second synchronization signals, and transmit a PRACH in the RO.

In various embodiments, the UE may also receive third information for a number of configurations for reception of CSI-RSs receive, during the non-active period of the cell DTX/DRX operation, a second candidate from the candidates that provides a second DL WUS, wherein the second DL WUS indicates an index of a configuration from the number of configurations, and receive the CSI-RSs, during the non-active period of the cell DTX/DRX operation, based on the configuration.

In various embodiments, the UE may also receive the first candidate on a first cell. The non-active period of the cell DTX/DTX operation is on the first cell when the first candidate is among first candidates or when an indication provided by the first DL WUS indicates the first cell. The non-active period of the cell DTX/DTX operation is on a second cell when the first candidate is among second candidates or when the indication provided by the first DL WUS indicates the second cell.

In various embodiments, the UE may also receive the first candidate based on a first number of receiver antennas and receive the number of second synchronization signals based on a second number of receiver antennas. The second number is larger than the first number.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information for time resources of candidates for a sequence-based downlink wake-up signal (DL WUS);
receiving second information for parameters of a cell discontinuous transmission or discontinuous reception (DTX/DRX) operation;
determining, based on the second information, a non-active period of the cell DTX/DRX operation;
determining, during the non-active period of the cell DTX/DTX operation, to:
skip receptions of first synchronization signals, and
receive, based on the first information, the candidates for the DL WUS within the time resources;
receiving, during the non-active period of the cell DTX/DRX operation, a first candidate from the candidates that provides a first DL WUS;
determining, based on the first DL WUS, to receive a number of second synchronization signals; and
receiving the number of second synchronization signals.

2. The method of claim 1, wherein receiving the number of second synchronization signals further comprises receiving the number of second synchronization signals within the non-active period of the cell DTX/DRX operation.

3. The method of claim 1, further comprising:
receiving a system information block (SIB) or cell-specific radio resource control (RRC) signaling, wherein the SIB or the RRC signaling indicates one or more of time, frequency, spatial, power, or sequence parameters for receiving the number of second synchronization signals.

4. The method of claim 1, further comprising:
receiving a system information block (SIB), wherein the SIB indicates random access channel (RACH) occasions (ROs);
determining an RO, from the ROs, that is associated with a synchronization signal from the number of second synchronization signals; and
transmitting a physical random access channel (PRACH) in the RO.

5. The method of claim 1, further comprising:
receiving third information for a number of configurations for reception of channel state information reference signals (CSI-RSs);
receiving, during the non-active period of the cell DTX/DRX operation, a second candidate from the candidates that provides a second DL WUS, wherein the second DL WUS indicates an index of a configuration from the number of configurations; and
receiving the CSI-RSs, during the non-active period of the cell DTX/DRX operation, based on the configuration.

6. The method of claim 1, wherein:
receiving the first candidate further comprises receiving the first candidate on a first cell,
the non-active period of the cell DTX/DTX operation is on the first cell when the first candidate is among first candidates or when an indication provided by the first DL WUS indicates the first cell, and
the non-active period of the cell DTX/DTX operation is on a second cell when the first candidate is among second candidates or when the indication provided by the first DL WUS indicates the second cell.

7. The method of claim 1, wherein:
receiving the first candidate further comprises receiving the first candidate based on a first number of receiver antennas,
receiving the number of second synchronization signals further comprises receiving the number of second synchronization signals based on a second number of receiver antennas, and
the second number is larger than the first number.

8. A user equipment (UE) comprising:
a transceiver configured to:
receive first information for time resources of candidates for a sequence-based downlink wake-up signal (DL WUS); and
receive second information for parameters of a cell discontinuous transmission or discontinuous reception (DTX/DRX) operation; and
a processor operably coupled with the transceiver, the processor configured to:
determine, based on the second information, a non-active period of the cell DTX/DRX operation; and
determine, during the non-active period of the cell DTX/DTX operation, to:
skip receptions of first synchronization signals, and
receive, based on the first information, the candidates for the DL WUS within the time resources,
wherein the transceiver is further configured to receive, during the non-active period of the cell DTX/DRX operation, a first candidate from the candidates that provides a first DL WUS,
wherein the processor is further configured to determine, based on the first DL WUS, to receive a number of second synchronization signals, and
wherein the transceiver is further configured to receive the number of second synchronization signals.

9. The UE of claim 8, wherein the transceiver is further configured to receive the number of second synchronization signals within the non-active period of the cell DTX/DRX operation.

10. The UE of claim 8, wherein:
the transceiver is further configured to receive a system information block (SIB) or cell-specific radio resource control (RRC) signaling, and
the SIB or the RRC signaling indicates one or more of time, frequency, spatial, power, or sequence parameters for receiving the number of second synchronization signals.

11. The UE of claim 8, wherein:
the transceiver is further configured to receive a system information block (SIB),
the SIB indicates random access channel (RACH) occasions (ROs),
the processor is further configured to determine an RO, from the ROs, that is associated with a synchronization signal from the number of second synchronization signals, and
the transceiver is further configured to transmit a physical random access channel (PRACH) in the RO.

12. The UE of claim 8, wherein the transceiver is further configured to:
receive third information for a number of configurations for reception of channel state information reference signals (CSI-RSs);
receive, during the non-active period of the cell DTX/DRX operation, a second candidate from the candidates that provides a second DL WUS, wherein the second DL WUS indicates an index of a configuration from the number of configurations; and
receive the CSI-RSs, during the non-active period of the cell DTX/DRX operation, based on the configuration.

13. The UE of claim 8, wherein:
the transceiver is further configured to receive the first candidate on a first cell,
the non-active period of the cell DTX/DTX operation is on the first cell when the first candidate is among first candidates or when an indication provided by the first DL WUS indicates the first cell, and
the non-active period of the cell DTX/DTX operation is on a second cell when the first candidate is among second candidates or when the indication provided by the first DL WUS indicates the second cell.

14. A base station comprising:
a transceiver configured to:
transmit first information for time resources of candidates for a sequence-based downlink wake-up signal (DL WUS); and
transmit second information for parameters of a cell discontinuous transmission or discontinuous reception (DTX/DRX) operation; and
a processor operably coupled with the transceiver, the processor configured to:
determine, based on the second information, a non-active period of the cell DTX/DRX operation; and
determine, during the non-active period of the cell DTX/DTX operation, to:
skip transmissions of first synchronization signals, and
transmit, based on the first information, the candidates for the DL WUS within the time resources;
wherein the transceiver is further configured to transmit, during the non-active period of the cell DTX/DRX operation, a first candidate from the candidates that provides a first DL WUS;
wherein the processor is further configured to determine, based on the first DL WUS, to transmit a number of second synchronization signals; and
wherein the transceiver is further configured to transmit the number of second synchronization signals.

15. The base station of claim 14, wherein the transceiver is further configured to transmit the number of second synchronization signals within the non-active period of the cell DTX/DRX operation.

16. The base station of claim 14, wherein:
the transceiver is further configured to transmit a system information block (SIB) or cell-specific radio resource control (RRC) signaling, and
the SIB or the RRC signaling indicates one or more of time, frequency, spatial, power, or sequence parameters for transmitting the number of second synchronization signals.

17. The base station of claim 14, wherein:
the transceiver is further configured to transmit a system information block (SIB),
the SIB indicates random access channel (RACH) occasions (ROs),
the processor is further configured to determine an RO, from the ROs, that is associated with a synchronization signal from the number of second synchronization signals, and
the transceiver is further configured to receive a physical random access channel (PRACH) in the RO.

18. The base station of claim 14, wherein the transceiver is further configured to:
transmit third information for a number of configurations for transmission of channel state information reference signals (CSI-RSs);
transmit, during the non-active period of the cell DTX/DRX operation, a second candidate from the candidates that provides a second DL WUS, wherein the second DL WUS indicates an index of a configuration from the number of configurations; and
transmit the CSI-RSs, during the non-active period of the cell DTX/DRX operation, based on the configuration.

19. The base station of claim 14, wherein:
the transceiver is further configured to transmit the first candidate on a first cell,
the non-active period of the cell DTX/DTX operation is on the first cell when the first candidate is among first candidates or when an indication provided by the first DL WUS indicates the first cell, and
the non-active period of the cell DTX/DTX operation is on a second cell when the first candidate is among second candidates or when the indication provided by the first DL WUS indicates the second cell.

20. The base station of claim 14, wherein:
the transceiver is further configured to transmit the first candidate based on a first number of receiver antennas,
the transceiver is further configured to transmit the number of second synchronization signals based on a second number of receiver antennas, and
the second number is larger than the first number.
